(19) United States
(12) Patent Application Publication
(10) Pub. No.: US 2006/0035223 A1
(43) Pub. Date: Feb. 16, 2006

(54) Method of isolating binding peptides from a combinatorial phage display library and peptides produced thereby

(76) Inventors: Rajesh R Naik, Dayton, OH (US); Morley O Stone, Bellbrook, OH (US); Daniel C Carter, Huntsville, AL (US)

Correspondence Address: STITES & HARBISON PLLC, 1199 NORTH FAIRFAX STREET, SUITE 900, ALEXANDRIA, VA, 22314, US

(21) Appl. No.: 10/507,028

(22) PCT Filed: Mar. 13, 2003
(86) PCT No.: PCT/US03/07617

§ 371 Date: May 17, 2005

Related U.S. Application Data
(60) Provisional application No. 60/363,551, filed on Mar. 13, 2002.
(60) Provisional application No. 60/369,330, filed on Apr. 3, 2002.

(51) Int. Cl. C40B 40/08; C40B 40/10

(52) U.S. Cl. 435/6; 435/7.1

(57) ABSTRACT

A method is provided for identifying and isolating peptides capable of binding of inorganic materials such as silica, cobalt, iron, or oxides thereof using a combinatorial phage display peptide library. In the method of the invention, a combinatorial phage display library is used to isolate and select the desired binding peptides by a series of steps of target binding of phage with the inorganic material of interest, elution and purification of the bound phages, and amplification to determine the sequences of phages producing the desired binding peptides. The binding peptides of the invention are particularly advantageous in that they may be used as templates to guide the development of useful structures on a nanometric scale.

### CROSS-REFERENCE TO RELATED APPLICATIONS

This application claims the benefit of U.S. Provisional Application Ser. No. 60/369,330, filed Apr. 3, 2002, and of U.S. Provisional Application Ser. No. 60/363,551, filed Mar. 13, 2002.

### FIELD OF THE INVENTION

This invention relates in general to a method for utilizing a combinatorial phage display library to produce binding peptides such as those which bind to inorganic materials and in particular to a method for isolating and producing peptides which bind to inorganic materials using a phage display library and utilizing the peptides obtained thereby to catalyze the precipitation and deposition of inorganic materials, such as metals and metal oxides, which are particularly useful in nanotechnological applications.

### BACKGROUND OF THE INVENTION

Biomineralization is a widespread phenomenon in nature. Many biological systems are capable of forming structures from varied inorganic substrates. For example, silver, magnetite, and cadmium sulfide particles can be microbially produced, and marine organisms such as diatoms and sponges are known to synthesize siliceous structures. In general, the transformation of inorganic molecules into nano- and microstrutured components on the biological scale appears to be controlled by proteins. However, the use of proteins to possibly direct the assembly of nanostructured components into sophisticated functional structures has not heretofore been possible and has long been a desired goal. The ability to utilize proteins to produce nanostructured inorganic materials, such as those made of silica or other similar compounds in vivo under ambient conditions would provide a significant advantage over traditional approaches to materials synthesis which require stringent conditions such as high temperature, pressure and pH. It is thus highly desirable to be able to produce nanometric metallic or other inorganic materials using a biomimetic approach which will only require ambient conditions to produce useful inorganic structures such as those useful on a nanometric scale.

In the biological arts, it has long been known to utilize a phage display library to express a particular protein. Phage peptide display is a selection technique in which random peptides from a library are expressed as a fusion with a phage coat protein, resulting in the display of the fused protein on the surface of the phage particle. The advantage of phage display technology is that it can offer the ability to identify surface-specific proteins in a more practical way and avoid the lengthy and complex identification procedures associated with traditional protein isolation and gene sequencing. However, it has not previously been known to utilize phage display technology in such a manner as to identify and produce peptides which can exhibit binding and nucleation properties against an inorganic material such as silica, silver, cobalt, iron, etc., in order to direct the precipitation of these materials so as to be able to create useful structures on a nanometer scale. Accordingly, it is thus highly desirable to develop a method for utilizing phage display libraries in order to allow rapid selection of surface-specific peptides and identify a subpopulation of silica-precipitating peptides, or peptides that can be used to catalyze the precipitation or deposition of other inorganic materials, and to use such peptides as templates for “bottom-up” microfabrication.

In addition, there are numerous applications wherein the delivery or removal of inorganic agents plays an important role in the complexity, expense and efficiency of the particular method. For example, in the case of toxic waste areas, it is very often the case that the most toxic ingredients that need to be removed from a site are the heavy metals which are extremely toxic and sometimes even radioactive. In the case of the infamous Love Canal site, metals in toxic levels discovered at the site included aluminum, antimony, beryllium, cadmium, copper, iron, lead, selenium, silver and zinc. At present, although there are many known methods for attempting to remove toxic levels of metals at such a site, many of these methods are often expensive, inefficient and general in nature and thus may not be adequate to eliminate or reduce levels of particular metals. Even further, it is important to be able to clean up and contain radioactive waste which may also be present at such sites, and once again it is desirable to achieve a method and product whereby such radioactive materials can be specifically bound and removed when necessary.

It is thus highly desirable to develop methods of obtaining materials which can be utilized which are very specific in terms of binding of metals and other toxic or potentially toxic inorganic materials, such as radioactive materials, which can thus be used to reduce or eliminate specific inorganic toxins from an environment. Similarly, there are now known methods of treating a human or animal patient which attempt to remove or eliminate toxic levels of potentially harmful inorganic materials such as lead from the body. Once again, present methods for doing this suffer from inefficiencies because the agents used to remove toxins, e.g. “chelating” agents, are normally not very specific. It is thus a desirable object to development methods and products which can be used safely and effectively to specifically remove toxic inorganic materials from the body.

It is still further the case that there are many applications wherein delivery or removal of radioactive materials is very important. In medical applications, it is now a standard procedure to treat patients with cancerous tumors with radiation therapy involving the administration of radiation from materials such as radioactive cobalt. However, in this case, it is often difficult to direct the radiation directly to the point where it is needed, namely directly at the tumor cells. Accordingly, it is thus a desirable object to be able to direct radiation treatment directly to specific cells so as to maximize the effects of the radiation against the tumor while minimizing the potential harm and side effects to the patient.

### SUMMARY OF THE INVENTION

Accordingly, it is thus an object of the present invention to provide a method for isolating and producing peptides which can catalyze the precipitation and/or deposition of inorganic materials such as silica, silver, or other valuable metals.

It is further an object of the present invention to provide a system wherein a phage display peptide library is used in the identification and isolation of peptides which can bind silica or other inorganic materials and which can thus be useful in methods of fabricating structures on an nanometric scale.

It is still further an object of the present invention to isolate and identify useful peptides which can bind to inorganic materials using a method that is quick, efficient, and which can be carried out without the need for rigorous physical conditions.

It is still further an object of the present invention to develop and provide peptides and proteins which can be used to catalyze the precipitation and deposition of useful inorganic materials such as silica, silver, germanium, cobalt oxide, iron oxide and other metals and metal oxides.

It is yet further an object of the present invention to isolate and identify useful peptides which can bind to potentially toxic inorganic materials and thus be used in methods of delivering or removing said materials when necessary.

It is yet further an object of the present invention to develop and provide peptides which can be used to remove or delivery radioactive materials in an efficient and relatively inexpensive manner.

These and other objects are achieved by virtue of the present invention which provides a method for identifying and isolating peptides capable of binding to inorganic materials using a combinatorial phage display peptide library. In the method in accordance with the invention, a combinatorial phage display library is used to isolate and select the desired binding peptides by a series of steps of target binding, elution and amplification which may be repeated until the desired amount of phage expressing peptides with the desired binding properties is obtained. Once these phage are isolated and/or purified following this procedure, the sequences of the binding peptides of the present invention may then be obtained, and the peptides then may be synthesized and used as templates to guide the precipitation development of useful structures on a nanometric scale.

These and other features of the present invention as set forth in, or will become obvious from, the detailed description of the preferred embodiments provided hereinbelow.

### BRIEF DESCRIPTION OF THE DRAWING FIGURES

FIG. 1A is a depiction of a scanning electron micrograph of biosilica catalyzed by the R5 peptide, scale bar 1 μm. FIG. 1B shows the multiple sequence alignment of silica binding peptides obtained after the third and fourth round of panning in accordance with the invention. The clone Si3-4, was the fourth clone selected from the third round of panning. The sequence alignment was obtained using CLUSTALW using default parameters. Amino acids that have functional side chains that are able to interact with the silica surface are shaded. R5 unit peptide sequence of silaffin-1 is shown for comparison. Peptide sequence Ge4-1 (arrow head), isolated by panning against germanium, was used as a control in our experiments. Some clones were isolated more than once (asterisk).

FIG. 2 is a depiction of the recognition of silica by phage displayed peptides, including FIG. 2A which shows immunofluorescence localization of representative phage peptide clones (Si3-4 and Si4-1) bound to silica. In the control experiments, no primary antibody (Anti-Fd) was added or a non-specific peptide clone Ge 4-1 was incubated in the presence silica. The light micrographs (left) show the silica particles. FIG. 2B is a graph which shows quantitation of the binding of peptide clones to silica by a phage immunoassay. As set forth below, the binding of biotin conjugated Anti-Fd to the phage-silica complex was detected using streptavidin-horseradish peroxidase.

FIG. 3 is a graph which shows silica condensation of the phage binding clones in accordance with the invention. As set forth below, equal amounts of phage particles (10¹¹) were incubated for 5 min in Tris-buffered saline pH 7.5 with hydrolyzed tetramethyl orthosilicate (TMOS) as described in materials and methods. The silica precipitate was collected washed and dissolved in 1 M NaOH at 95° C. for 30 min. The amount of silica was measured using the spectrophotometric molybdate assay. M13 control phage and the germanium binding phage clone Ge4-1 were used as negative controls. For comparison, the silica concentration obtained using R5 peptide (100 μg) was 1.05 μmol. The amount of silica precipitated from silicic acid is proportional to the amount of Si4-1 phage particles added.

FIG. 4A depicts a set of SEM micrographs of silica precipitated by the phage peptide clones. The diameter of the silica nanoparticles is between 200-400 nm, scale bar, 500 nm. FIG. 4B shows an EDS analysis of the nanoparticles exhibiting a high content of silica. Electron diffraction pattern of the nanoparticles indicates amorphous silica (inset).

FIGS. 5A-5B show the absorption spectra of biosynthetic silver nanoparticles used in the present invention including FIG. 5A which shows UV-Vis spectra of dispersed silver particles synthesized by the silver-binding phage clones. Phage clone Ge10 was used as control. FIG. 5B shows the UV-Vis spectra of silver particles obtained from AG4 peptide. AG4 peptide in an aqueous solution of 0.1 mM silver nitrate before (dashed line) and after 48 hrs of incubation at room temperature (solid line). The spectrum of a control peptide is after 48 hrs of incubation in 0.1 mM silver nitrate.

FIGS. 6A-6E shows the characterization of biosynthetic silver nanoparticles, including FIG. 6A which shows a variety of crystal morphologies were obtained using AG4 clone. The silver nanoparticles obtained using AG4 peptide are shown in Figure B and FIG. 6C. Inset (in 6B) shows the electron diffraction pattern obtained from the silver particle. The spot array for the crystals in (B) is from the [111] beam direction, for a fcc crystal. FIG. 6D shows the edge of the truncated triangle showing the thickness of the plate. Scale bar in B-D is 50 nm. FIG. 6E shows the EDX spectrum for the crystals which indicates the presence of elemental silver. Copper and carbon signal are caused by the TEM grid used for TEM analysis.

FIG. 7 is a schematic representation of a model for silver crystal formation by silver-binding peptides in accordance with the present invention.

FIGS. 8A-C show arrays of biosynthesized silver particles formed on a glass substrate using micromolding in capillaries (MIMIC). FIG. 8A shows a patterned elastomer (PDMS) mold used to create microfluidic channels that serve to guide the AG4 peptide solution on the glass substrate by capillary action. The peptides adsorb on the glass surface in a pattern defined by the network. FIG. 8B is a light micrograph showing the linear arrays of silver obtained after incubation of the AG4 patterned glass substrate with 0.1 mM silver nitrate for 48 hours at room temperature. FIG. 8C shows auto-fluorescence of the biologically synthesized silver particles when excited with a mercury lamp. Scale bar is 20 μm.

FIG. 9 is a schematic representation of the selection of silver binding peptides in accordance with the present invention.

FIG. 10 is another schematic representation of the selection of silver binding peptides in accordance with the present invention.

FIG. 11 is a representation of characteristics of selected clones in accordance with the present invention.

### DETAILED DESCRIPTION OF THE PREFERRED EMBODIMENTS

In accordance with the present invention, there is provided a method for utilizing a combinatorial phage display library to identify and obtain peptides which can bind to inorganic materials such as silica and other metals and metal oxides and which can be used to catalyze the precipitation and deposition of those materials on a nano/micrometer scale. In the preferred process, the inorganic material-binding peptides are obtained using a suitable combinatorial phage display peptide library such as would be commercially available and well known in the art. Phage peptide display is a selection technique in which a library of random peptides are expressed as a fusion with a phage coat protein resulting in the display of the fused protein on the surface of the phage particle. In the present invention, a suitable combinatorial library will be one in which phage expressing metal or metal oxide-binding peptides can be identified. One such combinatorial phage display library is the 12 amino acid phage peptide display library (PhD-12) was purchased from New England Biolabs, Inc (Beverly, Mass.). The phage-display peptide library consists of 10⁹ different phage clones, each displaying a unique 12 amino acid peptide on the phage surface.

In the general process of the invention, as explained further below, the inorganic material-binding peptides of the invention are obtained by first incubating the target particles with the combinatorial phage display peptide library. As indicated below, target particles in accordance with the invention will include any suitable inorganic material that can be bound by peptides and which can be deposited or precipitated to form an appropriate nanostructure. Examples of such inorganic materials include metals and metal oxides currently used in applications on a nanometric scale including silica, silver, germanium, iron, cobalt and the oxides of these metals. In addition, it is also possible to bind other inorganic materials which may be important in methods of removing or delivering these metals or oxides for various purposes. Accordingly, inorganic materials that can be removed using the process of the invention include aluminum, antimony, beryllium, cadmium, copper, iron, lead, selenium, silver and zinc. Another application of the invention will be in the recovery of potentially valuable metals which are normally mined from aqueous environments such as lakes, streams, etc., and these would include gold, platinum, palladium, and oxides thereof. Finally, it is also desired to develop means of either removing or delivering radioactive metals, such as uranium, radioactive cobalt, etc., and thus these metals as well can be bound using the peptides prepared in accordance with the process of the invention, as explained further below.

In short, the present invention can be used to obtain peptides that will specifically bind with all of the inorganic elements conventionally known, where stable in the pure form, such as would be reflected in the Periodic table of elements. It is also contemplated that the present method will be useful to isolate and/or identify peptides which can bind to these inorganic elements along with their stable inorganic complexes as well, e.g., oxides, etc. of these elements.

In the preferred process, as explained further below, the phages from the combinatorial library are identified and selected for their ability to express peptides that exhibit selective affinity for a particular inorganic material and which will be able to guide the deposition and precipitation of that material such as in the form of a template for nanometric structures

As indicated above, in accordance with the present invention, it is preferred that a combinatorial phage display peptide library such as the 12 amino acid phage peptide display library (PhD-12) be utilized in the invention, however, other available amino acid libraries having suitable peptides of other lengths would also be useful in the invention. In the preferred process, the phage display library is incubated with the desired target inorganic material as described above so as to target phage which express peptides capable of binding with that material. Accordingly, the invention includes a step of isolating the desired phage such as by eluting the phage bound to the target and separating and collecting the desired phage. The use of the target particle to identify and isolate phage which express the peptides with the desired binding properties is known as “panning” or “biopanning”, and in the preferred process, multiple rounds of panning may be carried out as desired to further purify the selected phage and increase the likelihood that the eluted and isolated phage will bind specifically to the target inorganic material. Ideally, the target particle is first itself isolated and purified before being used in the present process.

In the final step of the process, once the desired phage expressing the peptides are isolated and/or purified as described above, the nucleic acid (e.g., DNA) from the selected phages are then isolated and sequenced to obtain the genetic information encoding for the displayed peptides. A number of suitable techniques well known in the art may be used to obtain said sequences, including amplification of the genetic material by known processes such as an automated sequencer or other suitable PCR techniques.

In one example of a process in accordance with the invention, the target material may be silica particles, and the target binding, elution and amplification may be carried out in a number of suitable ways well known in the art. For example, peptide library PhD-12 can be incubated with washed silica particles, e.g., in Tris-buffered saline containing 0.2%-0.4% Tween-20 (TBST) for 1 hr at room temperature. The silica particles can then be washed several times with a buffer such as TBST buffer. The phage can then be eluted from the particles by the addition of a suitable eluting solution such as glycine-HCl (pH 2.2). The eluted phage can then be transferred into a fresh tube and neutralized, e.g., with Tris-HCl pH 9.1. In the preferred process, the eluted phage can be titered, and several additional rounds of panning can be carried out as desired.

After the final panning procedure, the eluting phage expressing the desired peptides may be amplified and sequenced in any of a number of suitable methods well known in the art. For example, E. coli host cells, such as ER2537, may be infected with the eluted phage and plated using a suitable nutrient broth to promote growth. One such suitable means is the use of Luria Broth (LB) plates containing 5-bromo-4-chloro-3-indoyl-β-D-galactosidase (X-Gal) and isopropyl-β-D-thiogalactosidase (IPTG). In this example, nucleic acid, e.g., DNA, may be isolated from blue plaques and sequenced using an automated sequencer such as the ABI 310 sequencer manufactured by PE Applied Biosystems, California. The final product may also be screened for precipitating activity to confirm the ability of the eluted phage to express peptides that can be used to form templates for the development of microstructures of inorganic material. In this manner, the present invention provides a more practical approach for identifying peptides that can bind to particular target particles than traditional approaches of gene identification from biological systems wherein time-consuming procedures such as protein isolation, amino acid sequencing and gene identification are required. In addition, this technique can be used to rapidly identify a sub-population of catalytic peptides from the larger pool of surface-specific peptides as demonstrated herein.

As indicated above, the process of the invention can be carried out on any desired inorganic material that is useful in applications where such materials may be deposited or precipitated on a nanometric scale to form suitable structures such as those used in sensor arrays, microchips, etc. Among the inorganic materials useful in the invention are silica, silver, germanium, cobalt, iron, and the oxides of these metals. Accordingly, the present invention includes those phage expressing peptides which bind to the target inorganic materials as well as to the amino acid sequences of the expressed peptides and the nucleic acid sequences encoding said amino acids. Examples of suitable peptides obtained in accordance with the invention are indicated as follows:

Silica Binding Peptides:

| | | |
|---|---|---|
| Si3-3 | APPGHHHWHIHH | (SEQ ID NO: 1) |
| Si3-4 | MSASSYASFSWS | (SEQ ID NO: 2) |
| Si3-8 | KPSHHHHHTGAN | (SEQ ID NO: 3) |
| Si4-1 | MSPHPHPRHHHT | (SEQ ID NO: 4) |
| Si4-3 | MSPHHMHHSHGH | (SEQ ID NO: 5) |
| Si4-7 | LPHHHHLHTKLP | (SEQ ID NO: 6) |
| Si4-8 | APHHHHPHHLSR | (SEQ ID NO: 7) |
| Si4-10 | RGRRRRLSCRLL | (SEQ ID NO: 8) |

Germanium Binding Peptides:

| | | |
|---|---|---|
| Ge4-1: | TVASNSGLRPAS | (SEQ ID NO: 9) |

Silver Binding Peptides:

| | | |
|---|---|---|
| Ag3 | AYSSGAPPMPPF | (SEQ ID NO: 10) |
| Ag4 | NPSSLFRYLPSD | (SEQ ID NO: 11) |
| Ag5 | SLATQPPRTPPV | (SEQ ID NO: 12) |

Cobalt Oxide Binding Peptides

| | | |
|---|---|---|
| c6-7 | --HPPTDWMVPSPP-- 12 | (SEQ ID NO: 13) |
| c6-9 | -TWQPFG-MRPSDP- 12 | (SEQ ID NO: 14) |
| c2 | ---HSVRWLLPGAHP- 12 | (SEQ ID NO: 15) |
| c5-3 | -KLHSSPHTLP-VQ-- 12 | (SEQ ID NO: 16) |
| c5-6 | ---TNLDPSYPLH-HL 12 | (SEQ ID NO: 17) |
| c5-7 | LPLLGDSIPHS-H- 12 | (SEQ ID NO: 18) |
| c5-8 | SPL-QVLPYQGYV 12 | (SEQ ID NO: 19) |
| c9 | ---TPNSDALLTPAL- 12 | (SEQ ID NO: 20) |
| c5-2 | --WTPGSTGLFHPN- 12 | (SEQ ID NO: 21) |
| c10 | ---QHITQSIWPGVR- 12 | (SEQ ID NO: 22) |
| c6-8 | ---QNFLQVIRNAPR- 12 | (SEQ ID NO: 23) |
| c5 | ---ESIPALAGLSDK- 12 | (SEQ ID NO: 24) |
| c5-4 | --PHILLTQMTSSG-- 12 | (SEQ ID NO: 25) |
| c6-4 | ----QLSKLISVSGSA 12 | (SEQ ID NO: 26) |
| c5-10 | ---TPLP-MIPAKRSF 12 | (SEQ ID NO: 27) |
| c3 | HETNPPATIMPH---- 12 | (SEQ ID NO: 28) |
| c6-3 | ---TGDVSNNPNVTL- 12 | (SEQ ID NO: 29) |
| c6-2 | --HAMRPQVHPNYA-- 12 | (SEQ ID NO: 30) |
| c6-6 | -YGNQTPYWYPHR--- 12 | (SEQ ID NO: 31) |
| c7 | ---TARTNEYPTGTS- 12 | (SEQ ID NO: 32) |
| c8 | ---RPAIVTQPWTIE- 12 | (SEQ ID NO: 33) |
| c5-1 | ---SLTQTVTPWAFY- 12 | (SEQ ID NO: 34) |
| c4 | --WASAAWLVHSTI-- 12 | (SEQ ID NO: 35) |
| c6-5 | -VLVAEQRVIMDQ--- 12 | (SEQ ID NO: 36) |
| Co-1 | SVSVGMKPSP-RP 12 | (SEQ ID NO: 37) |
| Co-12 | GTST-FNSVPVRD 12 | (SEQ ID NO: 38) |
| Co-13 | SAPN-LNALSAAS 12 | (SEQ ID NO: 39) |

Iron Oxide binding Peptides

| | | |
|---|---|---|
| RN-22 | TGIPKSLTVTFP | (SEQ ID NO: 40) |
| RN-23 | NLSTYLKTAVPP | (SEQ ID NO: 41) |
| RN-24 | SHNLEKSTARYP | (SEQ ID NO: 42) |
| RN-25 | SPGKTPGWVSSD | (SEQ ID NO: 43) |
| RN-27 | MNVTLSSSLDGP | (SEQ ID NO: 44) |
| RN-28 | QSFASLTNPRVL | (SEQ ID NO: 45) |
| RN-29 | VYIPKTPHAAPP | (SEQ ID NO: 46) |
| RN-30 | MNSIKPKPHHKN | (SEQ ID NO: 47) |
| RN-31 | GVLNAAQTWALS | (SEQ ID NO: 48) |
| RN-33 | TSSTKITWISTPS | (SEQ ID NO: 49) |
| RN-34 | VSFKPMALDFKF | (SEQ ID NO: 50) |
| RN-35 | LTQPTSKSPTMI | (SEQ ID NO: 51) |
| RN-36 | AMIPIAHHSANL | (SEQ ID NO: 52) |
| RN-37 | QHANHQAWNNLR | (SEQ ID NO: 53) |
| RN-38 | IHSVHFRSPPHP | (SEQ ID NO: 54) |
| RN-40 | MNMNQYTILSRT | (SEQ ID NO: 55) |

As indicated above, these peptides may be expressed and utilized in a number of suitable applications as would be understood by one skilled in the art, but in particular, the inorganic material-binding peptides are obtained by virtue of the present invention are ideally used as templates in inorganic material synthesis and may be used to guide the development of important microstructures on a nanometric scale such as would be used in sensors, computer chips and the like. In the preferred embodiments, the peptides obtained in accordance with the invention will be suitable for catalyzing and promoting the precipitation or directing growth of the particular inorganic material which is the target of the peptide of the invention.

In addition to the embodiments described above, the present invention may be used in a number of beneficial applications. For example, it is also possible to bind other inorganic materials which may be important in methods of removing or delivering these metals or oxides for various purposes. Accordingly, the present invention contemplates a method for recovering an inorganic material using a peptide identified and/or isolated in accordance with the invention as set forth above, by introducing an amount of the said peptide to the area or site where recovery or elimination of the particular inorganic material is desired, maintaining said peptide at said site for a time effective to achieve the desired level of peptide binding to the inorganic material, and then removing the bound peptide so as to recover or eliminate the particular metal bound by the peptide. In these applications, the effective amount of the peptide will vary depending on the type of application, and one skilled in the art would appreciate that each individual job would have an appropriate amount of peptide depending on the circumstances of the application.

For example, the peptides of the invention can be used in cases wherein recovery of a valuable inorganic material is desired, such as the mining of metals such as silver, gold or platinum from lakes and streams. In these applications, a number of suitable ways could be used to carry out such removal, including use of synthesized versions of the binding peptides identified from the above process, or via a recombinant genetic vector, such as an bacterial organism using a plasmid or viral vector with the genetic instructions to express the peptides in accordance with the invention. One suitable vector would be to have the peptides expressed in E. coli which could be prepared in suitable amounts, introduced to the body of water, whether natural stream or lake or artificial enclosure such as a tank or vat, given suitable time for the expression of the peptides and the binding to the precious metals, and then recovery or filtering of the peptides bound to the precious metals, following which the peptides could be separated through various means well known in the art. In addition, it is possible to prepare the peptides or E. coli expressing such peptides in a suitable vehicle, such as a filter or cartridge, e.g., where the peptides could be linked to a solid support (e.g., agarose, resins, polysaccharides, etc.) in such a way that their binding site is unaffected. Similar steps could be taken where the inorganic material is a toxic product, e.g., toxic metal waste or radioactive waste, and in these cases, the recovery of the metal in this procedure would be followed by its disposal or containment in a suitable manner. In addition, such peptides could be used in chelation methods of eliminating targeted inorganic materials from a human or animal patient.

Similarly, the present invention contemplates applications wherein delivery of a particular inorganic material is highly desirable, such as the direct application of a radioactive material, such as radioactive cobalt, to a tumorous cell in a cancer patient. In general, the method of delivering an inorganic material bound to a peptide identified and/or isolated in accordance with the invention as set forth above, can be carried out binding the peptide to the desired inorganic agent, and linking the bound peptide to a means of delivering the bound peptide to a particular site. For example, in the case of cancer treatment, it is possible to link the peptide to an antibody that can target particular tissues, such as cancerous tissues or cells, and the antibody-peptide-bound inorganic material complex can be introduced in a patient where it will apply the necessary agent, e.g., radioactive cobalt, directly to the site of the tumor. In such a case, the peptide will be appropriately linked to the antibody in such a manner that the binding property of the peptide to the inorganic material is unaffected and the target binding site of the antibody is unaffected.

Still other applications of the peptides of the invention would be in an area or site where recovery or elimination of the particular inorganic material is desired, maintaining said peptide at said site for a time effective to achieve the desired level of peptide binding to the inorganic material, and then removing the bound peptide so as to recover or eliminate the particular metal bound by the peptide. In these applications, the effective amount of the peptide will vary depending on the type of application, and one skilled in the art would appreciate that each individual job would have an appropriate amount of peptide depending on the circumstances of the application. Such a method will be useful in applications such as recovery or valuable metals or elimination of toxic inorganic materials. Another application of specific high binding peptides in accordance with the invention is that they can be directed to metals applied in NMR and X-ray contrast agents (e.g., as carried by the fragment or fused to a larger protein).

It is thus submitted that the foregoing embodiments are only illustrative of the claimed invention and not limiting of the invention in any way, and alternative embodiments that would be obvious to one skilled in the art not specifically set forth above also fall within the scope of the claims.

The following examples are presented as illustrative of the present invention or methods of carrying out the invention, and are not restrictive or limiting of the scope of the invention in any manner.

### EXAMPLES

### Example 1

### Isolation and Testing of Silica-Binding and Precipitating Peptides In Accordance with the Invention

Overview

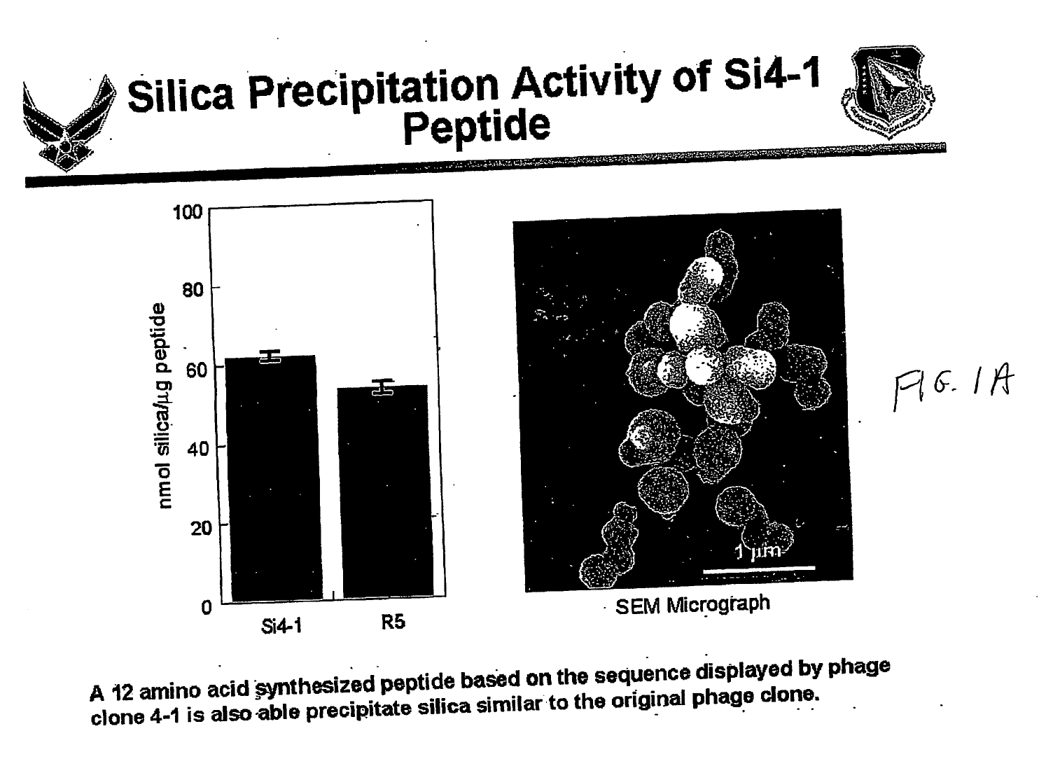

In accordance with the invention, a method was carried out in an effort to identify peptides from a combinatorial phage peptide display library that have the ability to catalyze silica precipitation based on the molecular recognition ability of the peptides for silica. We first screened a combinatorial phage peptide display library for peptides that specifically interact with silica and subsequently tested for silica precipitating activity. In order to isolate peptides that are able to bind to silica, we synthesized the target, biogenic silica, using the silaffin-derived R5 peptide as described by Kröger et al., (1999). The R5 peptide (FIG. 1B), a 19 amino acid peptide unit of silaffin-1 precursor polypeptide, is able to precipitate silica within minutes when added to a freshly prepared solution of hydrolyzed silicic acid. Scanning electron microscopy (SEM) analysis of the silica precipitate shows the presence of a network of silica spheres with a diameter of 400-600 nm (FIG. 1A). The biosilica precipitate was washed several times to remove residual peptide that bound to the surface of the particles and was used for panning against the phage display library.

The phage-display peptide library consists of 10⁹ different phage clones, each displaying a unique 12 amino acid peptide on the phage surface. The selection of silica-specific peptides was achieved by performing multiple rounds of binding to the target (silica), elution and amplification. Multiple rounds of panning using stringent conditions to selectively enrich for peptides that bound to silica were performed. DNA from several phage clones selected from the third (Si3-X) or fourth (Si4-X) round of panning was isolated and subsequently sequenced. Since the phage particle contains the DNA encoding the displayed peptide, the amino acid sequence of the selected peptide can be readily identified. The amino acid sequences of the silica-binding peptides are depicted in FIG. 1B. Some of the selected peptides were presented more than once in the pool of selected clones (asterisk). Analysis of the amino acid sequences of the selected peptides indicated a preferential enrichment of peptides rich in histidine and other amino acid residues with functional side chains capable of interacting with the silica surface, many residues being cationic in nature. For example, clones Si3-8, Si4-1, Si4-8 and Si4-10 have a predicted isoelectric pH of 8.78, 9.57, 9.83 and 12.3, respectively. In addition, these amino acid residues appear as clusters within the displayed sequence.

Experimental Protocol

The following procedures of preparation and testing were carried out in accordance with the invention, as explained further below:

Isolation of Silica Binding Peptides. A 12 amino acid phage peptide display library (PhD-12) was purchased from New England Biolabs, Inc (Beverly, Mass.). The target binding, elution and amplification was carried out according to manufacturer's instructions. Briefly, the peptide library was incubated with washed silica particles in Tris-buffered saline containing 0.2%-0.4% Tween-20 (TBST) for 1 hr at room temperature. The silica particles were then washed several times with TBST buffer. The phage were eluted from the particles by the addition of glycine-HCl (pH 2.2) for 10 min. The eluted phage were then transferred into a fresh tube and neutralized with Tris-HCl pH 9.1. The eluted phage were then titered and the subjected to 3-4 additional rounds of panning. After the final panning procedure, E. coli ER2537 host cells were infected with the eluted phage and plated on Luria Broth (LB) plates containing 5-bromo-4-chloro-3-indoyl-□-D-galactosidase (X-Gal) and isopropyl-□-D-thiogalactosidase (IPTG). DNA was isolated from at least 10 independent blue plaques and sequenced using an automated sequencer.

Silica Precipitation Assay. Either phage (10¹⁰-10¹² phage forming units) or R5 peptide (100 μg) was incubated in freshly prepared orthosilicic acid for 2-5 min at room temperature. The solution of orthosilicic acid was prepared by dissolving tetramethyl orthosilicate (Sigma, St. Louis Mo.) in 1 mM HCl to a final concentration of 1 M. Silica precipitation using synthetic peptides and phage displayed peptides was performed in TBS buffer pH 7.5. Appropriate controls (non-specific phage and peptide control) were always performed in parallel. The silica precipitate was washed several times in ultrapure water prior to further analysis.

Beta silicomolybdate Assay. Silica concentration in the samples was determined by the β-silicomolybdate method as described by Her (1979). The silica precipitate was dissolved in 1 M NaOH at 95° C. for 30 min. The reaction of molybdic acid with monomeric Si(OH)₄ gives a yellow product with an absorption maxima at 410 nm.

Scanning electron microscopy (SEM), Electron dispersive spectroscopy (EDS) and Electron diffraction. The silica precipitate was washed in distilled water, diluted, mounted and sputter-coated. Micrographs were obtained from silica samples coated with 10 Å of tungsten using a Hitachi S900 cold-field emission scanning electron microscope. Samples were prepared for electron dispersive spectroscopy (EDS) by sputter coating 20 Å of gold onto the samples. A Leica-Cambridge 360 FE SEM with a Noran Voyager electron dispersive spectrometer was used to verify that the observed structures were indeed silica. For electron diffraction, the silica precipitate was mounted onto carbon coated copper grids and analyzed using a Phillips transmission electron microscope (TEM).

Immunofluorescence Microscopy. The silica particles were washed several times in TBST buffer prior to incubation with phage particles (10⁵ pfu). The phage were allowed to react with the silica particles for 1 hr in TBST buffer and then washed 10 times in TBST to remove the unbound phage. The phage-silica particle complexes were then incubated with primary anti-fd antibody (Sigma, MO), an antibody raised against the pill coat protein (1:10,000 dilution in TBST) for 1 hr at room temperature and then rinsed several times in TBST. Decoration of the primary antibody was done using Texas Red-conjugated goat anti-rabbit secondary antibody. As controls, reactions with control phage (Ge4-1) or without primary antibody (anti-fd) were performed to confirm that there was no non-specific binding of the secondary conjugated antibody to the silica particles.

Phage Immunoassay. Equal amounts of washed biosilica particles were incubated with the phage particles (10⁵ pfu) for 1 hr followed by several washes in TBST buffer. Biotin conjugated anti-fd was added (diluted 1:10,000) to the silica-phage complexes and incubated for 1 hr in TBST buffer. The immunocomplexes were precipitated at 14,000 g for 5 min and washed several times. Streptavidin-Horseradish peroxidase (HRP) conjugate (diluted 1:1000) was added to the complexes and incubated for an additional hour followed by several washes. The detection of the captured streptavidin-HRP was performed using the calorimetric substrate 2,2-azinobis [3-ethylbenzothiazoline-6-sulfonic acid]-diammonium salt, (Pierce, USA).

Discussion of Experimental Procedures and Results

In accordance with the invention, the following silica-binding peptides were obtained using the method as described above:

| | | |
|---|---|---|
| Si3-3 | APPGHHHWHIHH | (SEQ ID NO: 1) |
| Si3-4 | MSASSYASFSWS | (SEQ ID NO: 2) |
| Si3-8 | KPSHHHHHTGAN | (SEQ ID NO: 3) |
| Si4-1 | MSPHPHPRHHHT | (SEQ ID NO: 4) |
| Si4-3 | MSPHHMHHSHGH | (SEQ ID NO: 5) |
| Si4-7 | LPHHHHLHTKLP | (SEQ ID NO: 6) |
| Si4-8 | APHHHHPHHLSR | (SEQ ID NO: 7) |
| Si4-10 | RGRRRRLSCRLL | (SEQ ID NO: 8) |

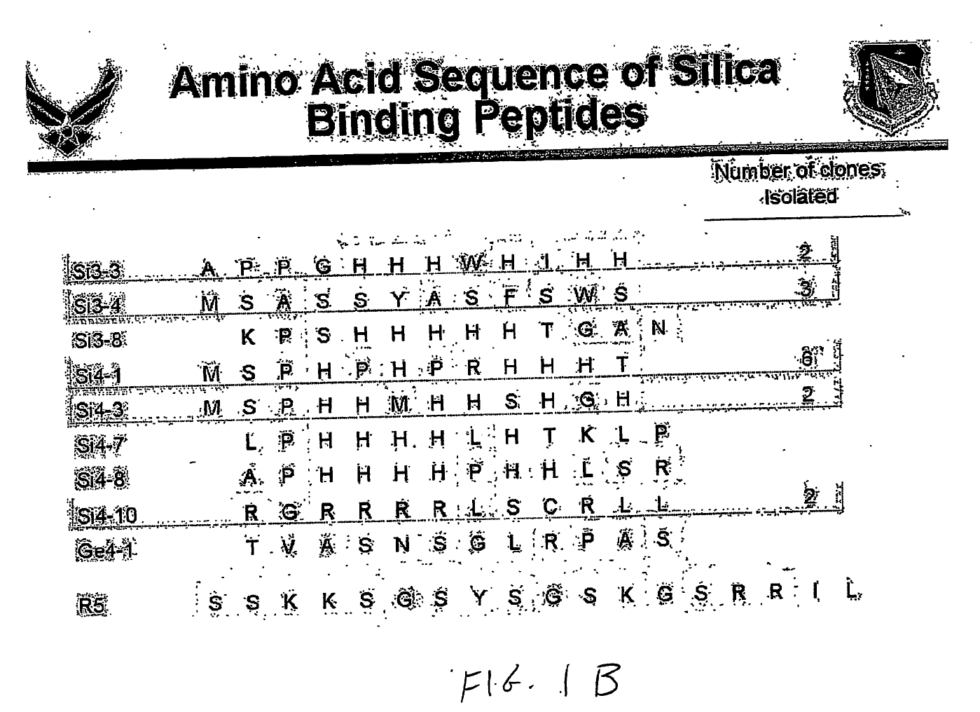

Immunofluorescence microscopy and a phage immunoassay confirmed the binding of the phage-displayed peptides to the surface of the silica particles. The silica particles were incubated with the selected phage particles and the binding of the phage to the silica surface was detected using anti-fd antibody by indirect immunofluorescence microscopy. The anti-fd antibody that recognizes the pill phage coat protein. The selected phage particles localize to the silica surface, suggesting that the phage clones selected by panning against silica do indeed bind to the inorganic material (FIG. 2A). In contrast, the peptide clone Ge 4-1 (previously isolated by panning against germanium) showed little or no binding to the silica particles. Likewise, the silica-binding phage clones fail to bind to germanium (data not shown). In order to quantitate the binding to the phage particles to silica, a phage immunoassay was performed (FIG. 2B). The silica-phage complex was first captured using biotin-conjugated anti-fd antibody. The captured immune complexes were then detected using streptavidin-labeled horseradish peroxidase (HRP). Addition of the substrate, 2,2-azinobis [3-ethylbenzothiazoline-6-sulfonic acid]-diammonium salt results in formation of a colored product that can be spectrophotometrically measured. As a result, the amount of colored product formed is proportional to the amount of streptavidin-HRP conjugate associated with the phage particles. The phage particles displaying the silica-binding peptides interacted strongly with the silica surface, while the non-specific clone Ge 4-1 and the filamentous phage M13, with no displayed peptides, exhibited minimal binding (FIG. 2B). In particular, phage clones Si4-1 and Si4-10 displayed strong binding to the silica surface. Both of these assays demonstrate that the selected phage peptide clones exhibited specific binding to the silica surface.

Previous studies have shown that cationic polymers and hydrogen bonding polymers can act as flocculating agents to catalyze silica condensation 16. Proteins that have a high cationic charge and amino acids with hydroxyl or imidazole side groups also promote silica precipitation. For example, silaffin-1, a polycationic protein containing a high proportion of hydroxy amino acids promotes silica precipitation probably by acting as a flocculating agent 3. The silica precipitation by silcateins proceeds through a hydrolysis reaction that requires both hydroxy and imidazole side chains 12,17. The silica-binding peptides that have been isolated in this study exhibited some or all of the characteristics that are inherent in silaffins or silcateins. For example, clones Si4-1 and Si4-8 contain hydroxy and imidazole side chains and are cationic. In contrast, clone Si4-10 is highly cationic but lacks both hydroxy and imidazole side chains while Si4-3 contains both hydroxy and imidazole side chains but is neutral in nature.

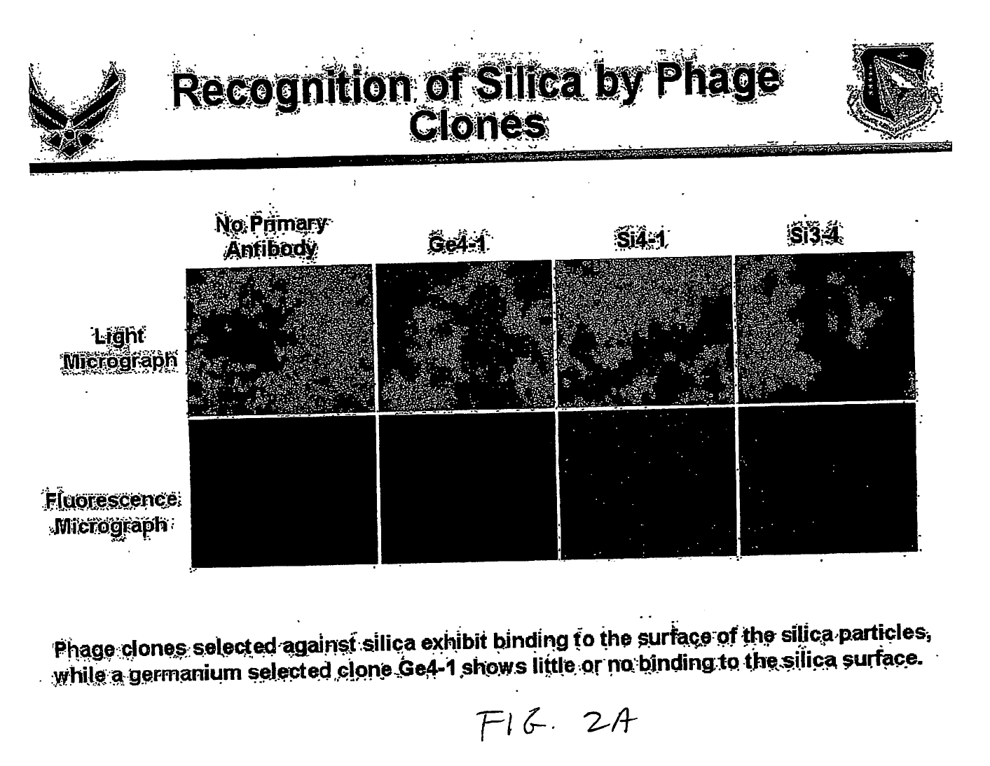

Encouraged by the sequence characteristics of the selected peptides, we next examined the selected phage peptide clones for silica precipitation activity. The phage peptide clones were tested for silica precipitating activity by incubating them in the presence of a freshly prepared solution of hydrolyzed silicic acid. The addition of silicic acid to some of the selected phage peptide clones resulted in the formation of a silica precipitate. Incubation of phage peptide clones Si3-4,3-8, 4-1,4-3 or 4-8 in the presence of silicic acid resulted in the formation of a visible precipitate. In contrast, no silica precipitate was visible with Si3-3, Si4-10, germanium binding clone Ge4-1 or when M13 phage particles were added to the silicic acid. The hydrolyzed silicic acid without added phage particles does not undergo spontaneous precipitation and remained homogenous for several hours. The amount of silica formed by the phage peptide clones was quantified by the molybdate assay. The molybdate assay is a colorimetric assay in which molybdic acid reacts with hydrolyzed silica [Si(OH)₄] to give silicomolybdic acid that can be spectrophotometrically measured at 410 nm¹⁶. The silica precipitate obtained from the phage peptide clones was collected and washed several times in ultrapure water and hydrolyzed with 1M NaOH prior to spectrophotometric analysis. As shown in FIG. 3, the peptide clones exhibit varying levels of silica precipitating activity. The highest activity was repeatedly observed with clone Si4-1 (680 nmol of silica). Si3-3, Si4-10, Ge4-1 and M13 phage particles exhibited little or no silica precipitating activity (<50 nmol). Furthermore, the addition of increasing amounts of the Si4-1 phage particles to silicic acid results in an increase in silica precipitate formation (FIG. 3 inset).

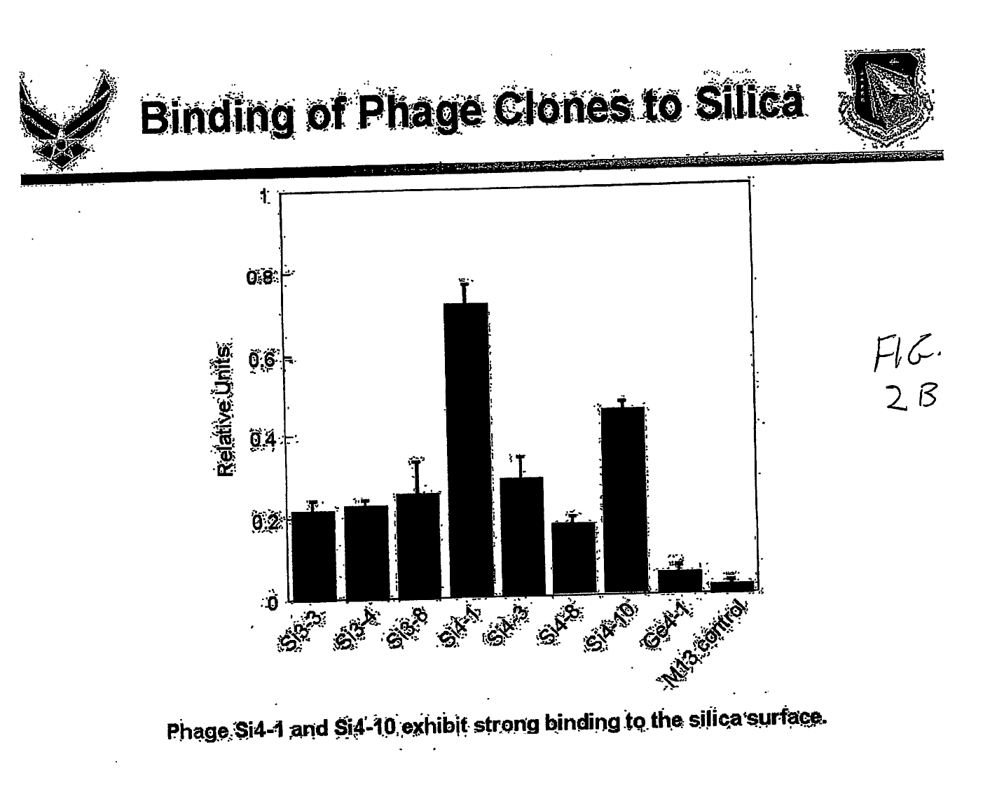

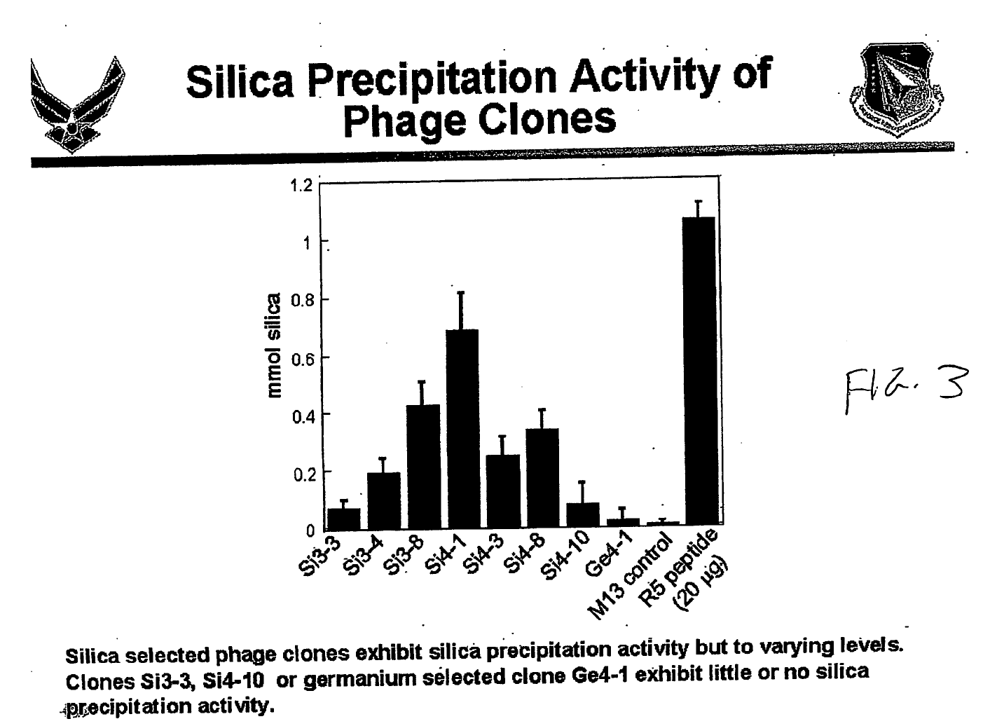

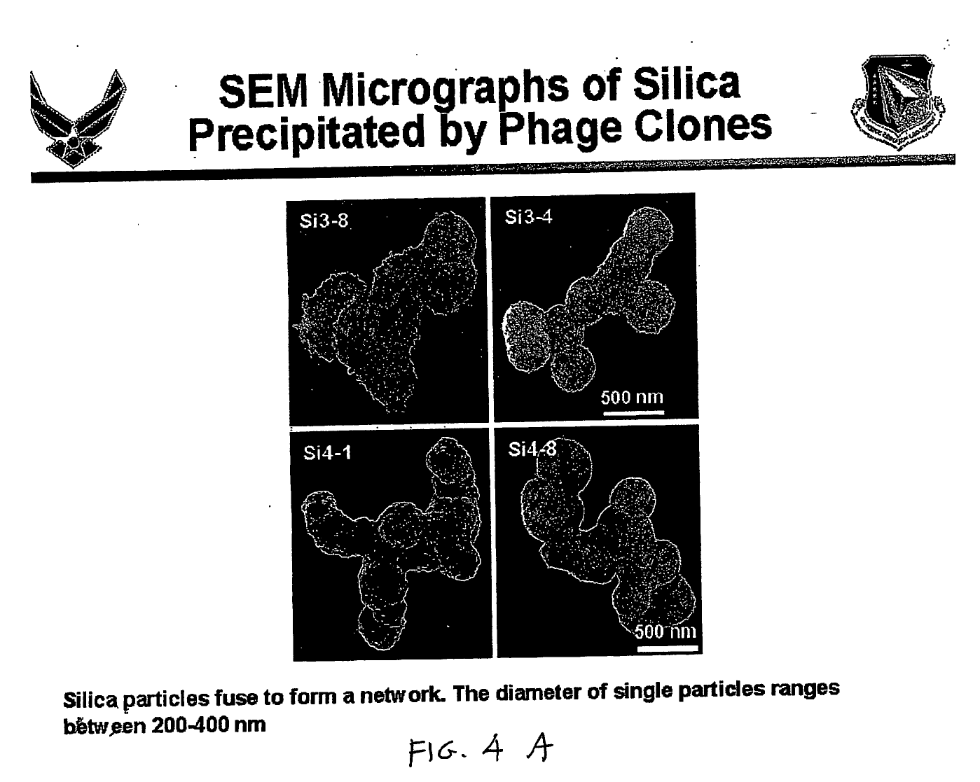

We next examined the silica precipitates using scanning electron microscopy (SEM). The SEM micrographs of the silica precipitates catalyzed by the phage peptide clones are shown in FIG. 4A. The silica precipitates obtained by the phage clones are primarily composed of a network of partially fused silica spheres with a diameter of 250-500 nm. Notwithstanding, the overall structure of the silica precipitate obtained using the selected phage clones appeared similar, although slight differences in the surface morphology can be observed. Electron dispersive spectroscopy (EDS) confirmed that the precipitate exhibited a high silicon content (FIG. 4B) and electron diffraction indicated that the silica particles are amorphous (FIG. 4B inset).

In this study, we have used a combinatorial phage peptide display library to select for peptides that exhibited selective binding to an inorganic material, i.e., silica. Furthermore, from these silica-binding peptides we were able to identify a sub-population of peptides that were also capable of catalyzing the formation of amorphous silica. From the amino acid sequences, we inferred that the presence of both hydroxy and imidazole containing amino acids and a high cationic charge are ideal for promoting silica precipitation from a silane precursor. However, the presence of either imidazole containing amino acids or a high cationic charge by themselves is insufficient to promote silica precipitation. In accordance with the invention, peptides based on the sequences obtained from our phage clones may be synthesized, and experimental results have shown that these peptides of the invention are also capable of silica precipitation activity. In conclusion, we have demonstrated the use of a combinatorial phage peptide display library to select for peptides that catalyze inorganic material synthesis.

We have now extended this approach to other inorganic substrates and these results are reported below.

The following references referred to in the above example are incorporated by reference as if set forth in their entirety herein:

### REFERENCES

1. Mann, S. Molecular tectonics in biomineralization and biomimetic materials chemistry. Nature 365, 499-505 (1993).
2. Morse, D. E. Silicon biotechnology: harnessing biological silica production to make new materials. Trends Biotechnol. 17, 230-232 (1999).
3. Kroger, N., Deutzmann, R. & Sumper, M. Polycationic peptides from diatom biosilica that direct silica nanosphere formation. Science 286, 1129-1132 (1999).
4. Dan, N. Synthesis of hierarchical materials. Trends Biotechnol. 18, 370-374 (2000).
5. Cha, J. N., Stucky, G. D., Morse, D. E. & Deming, T. J. Biomimetic synthesis of ordered silica structures mediated by block copolypeptides. Nature 403, 289-292 (2000).
6. Joerger, R., Klaus, T. & Granqvist, G. C. Biologically produced silver-carbon composite materials for optically functional thin film coatings. Adv. Mater. 12, 407-409 (2000).
7. Klaus-Joerger, T., Joerger, R., Olsson, E., & Granqvist, C. G. Bacteria as workers in the living factory: metal accumulating bacteria and their potential for materials science. Trends Biotechnol. 19, 15-20 (2001).
8. Schueler, D. & Frankel, R. B. Bacterial magnetosomes: microbiology, biomineralization and biotechnological applications. Appl. Microbiol. Biotechnol. 52, 464-473 (1999).
9. Taylor, D. E. Bacterial tellurite resistance. Trends Microbiol. 7, 111-115 (1999).
10. Williams, P., Keshavarz-Moore, E. & Dunnill, P. Production of cadmium sulphide microcrystallites in batch cultivation by Schizosaccharomyces pombe. J. Biotechnol. 48, 259-267 (1996).
11. Klaus, T., Joerger, R., Olsson, E. & Granqvist, C. G. Silver-based crystalline nanoparticles, microbially fabricated. Proc. Natl. Acad. Sci. U.S.A. 96, 13611-13614 (1999).
12. Cha, J. N. et al. Silicatein filaments and subunits from a marine sponge direct the polymerization of silica and silicones in vitro. Proc. Natl. Acad. Sci. USA 96, 361-365 (1999).
13. Brown, S. Metal-recognition by repeating polypeptides. Nature Biotechnol. 15, 269-272 (1997).
14. Whaley, S. R., English, D. S., Hu, E. L., Barbara, P. F. & Belcher, A. M. Selection of peptides with semiconductor binding specificity for directed nanocrystal assembly. Nature 405, 665-668 (2000).
15. Rodi, D. J., Makowski, L. Phage-display technology—finding a needle in a vast molecular haystack. Anal. Biotechnol. 10, 87-93 (1999).
16. Iler, R. K. The Chemistry of Silica (John Wiley & Sons, New York, 1979).
17. Zhou, Y., Shimizu, K. Cha, J. N., Stucky, J. D. & Morse, D. E. Efficient catalysis of polysiloxane synthesis by silicatein alpha requires specific hydroxy and imidazole functionalities. Angew. Chem. Int Edn Engl. 38, 780-782 (1999).

### Example 2

### Preparation of Silver Binding Peptides in Accordance with the Invention

Methods

In accordance with the present invention, the following techniques were utilized in the preparation of silver-binding peptides useful in the patterning of nanostructures:

Phage Display

Silver binding peptides were selected using the Ph.D.-12C phage display peptide library obtained from New England Biolabs, Inc (Beverly, Mass.). The target binding, elution and amplification were carried out according to manufacturer's instructions. Briefly, the peptide library was incubated with acid etched silver particles (nanosized activated powder, Aldrich, St Louis, Mo.) in Tris-buffered saline containing 0.1-0.5% Tween-20 (TBST) for 1 hr at room temperature. The silver-phage complexes were then washed several times with TBST buffer. The phages were eluted from the particles by the addition of glycine-HCl (pH 2.2) for 10 minutes. The eluted phage were then transferred to a fresh tube and neutralized with Tris-HCl, pH 9.1. The eluted phage were then tittered and subjected to 2-3 additional pannings. After the final panning procedure, Escherichia coli ER2537 host cells were infected with the eluted phage and plated on Luria Broth (LB) plates containing X-Gal and IPTG. DNA was isolated from 30 independent blue plaques and sequenced using an ABI 310 (PE Applied Biosystems, CA) automated sequencer.

Silver Precipitation Assay

The phage (10¹⁰-10¹¹ phage forming units) or synthetic 12-mer peptide (0.4 mg ml⁻¹) were incubated in 0.1 mM silver nitrate (AgNO₃) in TBS for 1648 hours at room temperature. Non-specific phage clone GE10 (SFLYSYTGPRPL) (SEQ ID NO: 56) or MT1 peptide (GTGEGCKTGCKC) (SEQ ID NO: 57) were used as controls. Particles were collected by ultracentrifugation. The particles were then washed with distilled water and stored for further analysis.

Transmission Electron Microscopy (TEM), Energy Dispersive X-Ray Analysis (EDX) and Electron Diffraction

The washed particles were mounted on carbon-coated copper grids. Micrographs were obtained using a Philips EM208 operating at 200 kV. EDX spectra were obtained on single particles using a Noran Voyager system attached to the TEM. For comparing different regions within a single crystal, the beam spot size and exposure times were kept constant. Electron diffraction for single crystals was also obtained on the Philips TEM.

Micromolding in Capillaries (MIMIC)

The MIMIC procedure was performed as described by Delamarche et al., 21. In brief, the mold placed on top of a poly-lysine coated glass slide and gently pressed onto the glass surface forming a tight seal. 5 μl of peptide solution (0.4 mg ml⁻¹), phage or control solution (TBS or water) was pipetted at the mold-slide interface. Filling of the capillaries occurred quickly and the mold was allowed to remain on the glass slide for 1 hour. The mold was then gently removed and the slide was immersed in distilled water for 5 minutes. The slide was briefly dried, placed in a humid chamber and overlaid with 0.1 mM silver nitrate. The slide was observed using a fluorescence light microscope after 48 hrs of incubation. As a control, a non-silver specific peptide was also used but no silver precipitation was observed.

Discussion of Methods and Results:

In accordance with the present invention, the silver-binding peptides were selected by incubating silver particles with a combinatorial phage display peptide library. The phages expressing peptides that exhibited selective affinity for silver, after several rounds of panning, were eluted from the surface of the silver particles and re-amplified. DNA from the phages were isolated and sequenced to obtain the genetic information encoding for the displayed peptides. Analysis of over 30 independent clones provided only three different peptide sequences as shown below and in Table 1:

| | | |
|---|---|---|
| Ag3 | AYSSGAPPMPPF | (SEQ ID NO: 10) |
| Ag4 | NPSSLFRYLPSD | (SEQ ID NO: 11) |
| Ag5 | SLATQPPRTPPV | (SEQ ID NO: 12) |

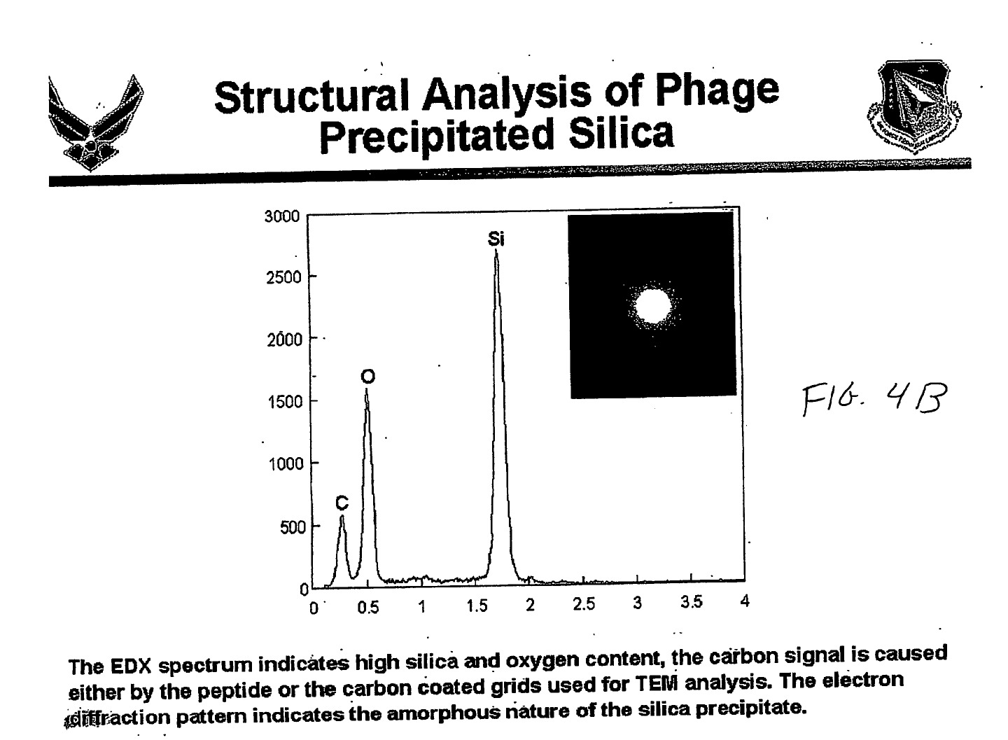

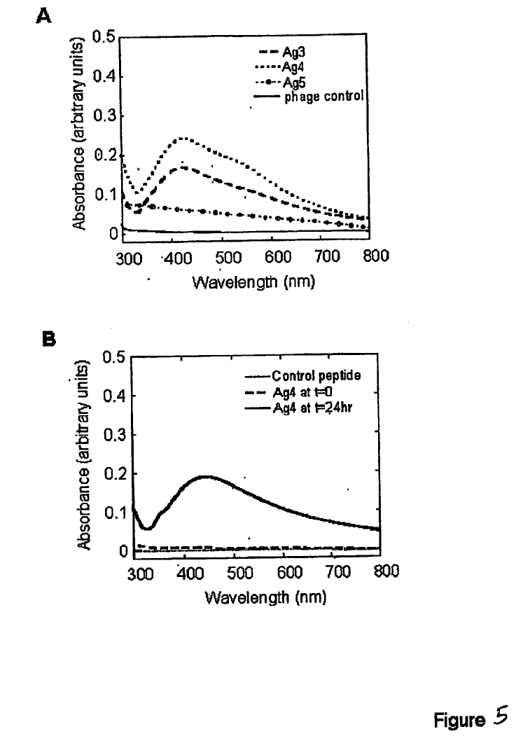

Of these three peptides, the AG4 peptide was the predominant sequence present within the sequenced clones. The silver-binding peptides do indicate a preferential enrichment of proline and hydroxyl-containing amino acids residues, and there appears to be positional conservation of some of the amino acid residues. We confirmed the binding of the phage clones to silver surfaces using indirect immunofluorescence (supplemental information, FIG. 5).

Interestingly, when the silver-binding clones were incubated in an aqueous solution of 0.1 mM silver nitrate for 24-48 hrs at room temperature, the solution turned reddish in color, and a reddish colored precipitate was obtained when the solution was centrifuged. No change in the color or precipitate was observed with a non-specific phage. Silver nanoparticles are known to exhibit a size-dependent characteristic surface plasmon resonance band that can be measured using ultraviolet-visible (UV-Vis) spectroscopy. We observed a characteristic surface plasmon absorption band at ˜440 nm in our silver nitrate solution incubated with the silver-binding peptides (FIG. 5A). The plasmon bands are broad with an absorption tail in the longer wavelengths. This broadening of the plasmon band could be in principle due to the size and shape distribution of the particles 17. Unlike AG3 and AG4, the AG5 phage clone exhibited very little silver precipitation and the UV-Vis spectrum of the AG5 solution showed no distinct absorption band. Peptides based on the sequence obtained from the phage clones were chemically synthesized and tested for silver precipitation. As expected, both AG3 and AG4 peptides exhibited silver precipitation, while AG5 peptide showed no precipitation of silver from the aqueous solution of silver ions. The UV-Vis absorption profile for silver precipitate obtained using AG4 peptide is shown in FIG. 5B. Both AG3 and AG4 peptide exhibit a similar plasmon resonance absorption band at ˜440 nm. The main biochemical difference between the silver precipitating peptides (AG3 and AG4) and AG5 is the overall charge of the peptide—AG5 is basic compared to AG3 and AG4 (Table 1). Based on these results, the silver-binding peptides selected from the combinatorial peptide library are capable of precipitating silver from an aqueous solution of silver ions. In contrast, pure amino acids such as proline, lysine, arginine or serine as well as other non-silver binding peptides were incapable of precipitating silver from a solution of silver nitrate (supplemental information).

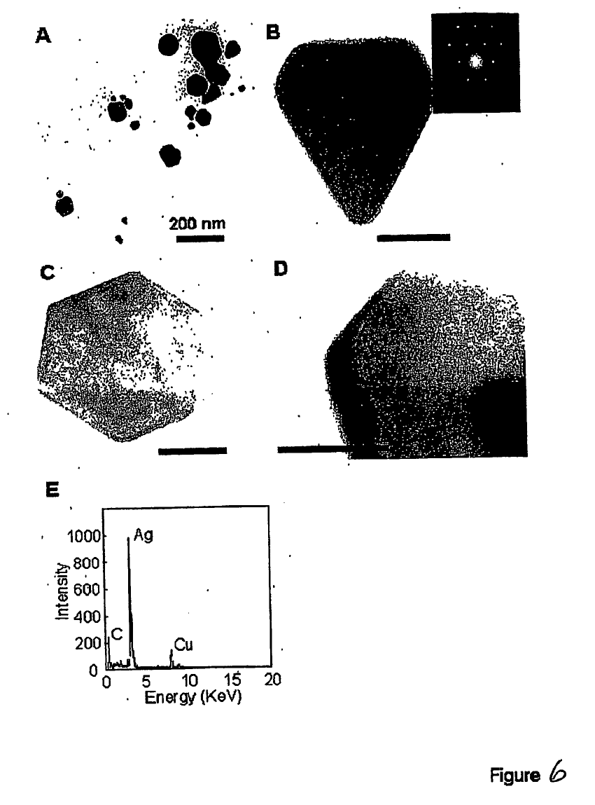

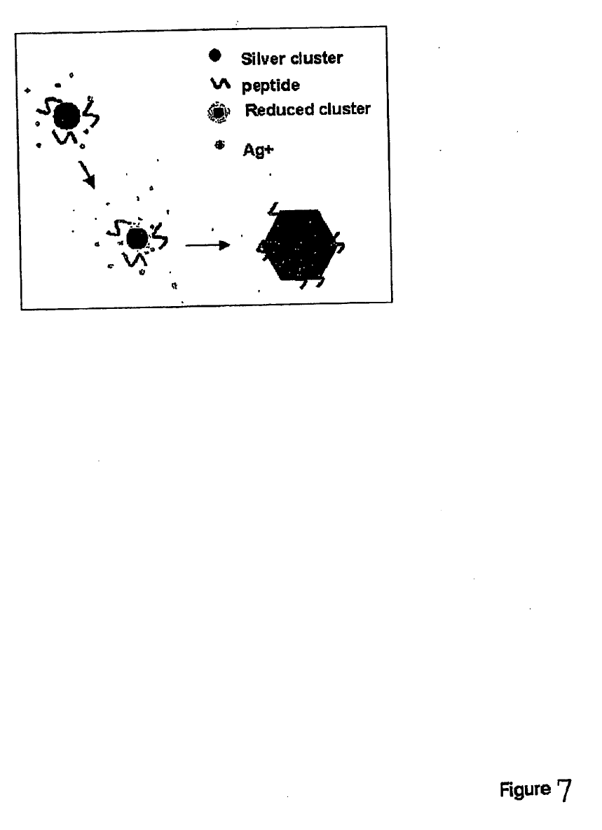

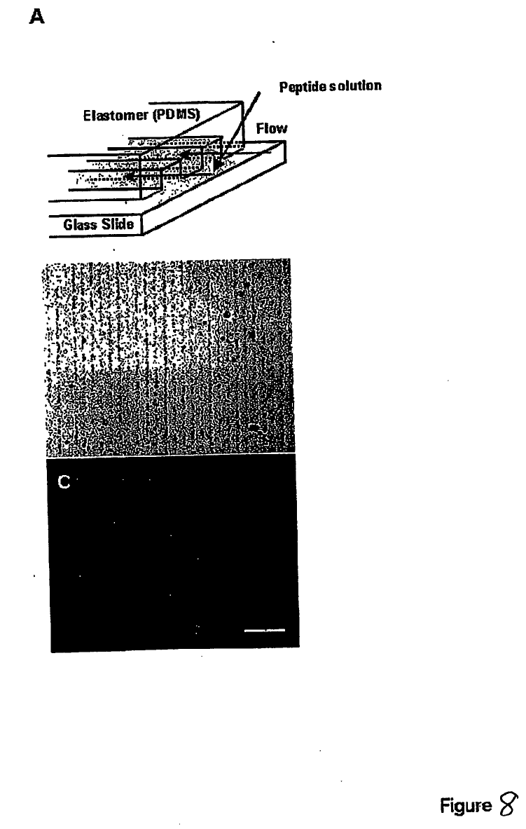

The silver particles obtained using the silver binding peptides were analyzed by TEM, energy-dispersive x-ray (EDX) analysis and electron diffraction. TEM of the silver particles synthesized by the silver-binding peptides showed the presence of silver particles 60-150 nm in size (FIG. 6). For example, examination of the silver nanoparticles obtained using AG4 peptide revealed the presence of hexagonal, spherical, and triangular silver particles (FIG. 6). The presence of polyhedral crystals influences the optical properties, substantiating the basis for the broad absorption of the plasmon resonance band. The electron diffraction patterns of the silver nanoparticles obtained using AG4 peptide indicate that the crystals have a face centered cubic (f.c.c) lattice structure corresponding to that of silver. The spot array for the crystal in FIG. 6B corresponds to the [111] beam direction. The [111] face is the large flat face of the silver crystal (FIG. 6B). The crystals exhibited a flat plate-like morphology and the thickness of the flat nanoparticles is ˜15-18 nm (FIG. 6D). Crystal shapes are dictated by the relative growth rates of the different crystallographic directions. Interaction of the peptide with the crystal lattice structure may influence the surface energies. The [111] face may have lower surface energy and the peptide may bias crystal growth by allowing accumulation of silver atoms onto the [111] face. It has been previously demonstrated that inorganic binding peptides control crystal growth and shape 6,18 Flat crystals with polyhedral morphologies were also observed in the microbially fabricated silver nanocrystals. The crystals that accumulate within the periplasmic space of P. stutzeri AG259 exhibited a large size range (100-200 nm) 4. We propose the following model for peptide-based silver crystal formation (FIG. 7). The silver binding peptides interact with preformed nanoclusters or nuclei of silver metal present in the aqueous silver nitrate solution. These metal clusters assume a variety of structures, some of which are similar to that of the mature crystal. The interaction of peptide with the metal clusters provides a chemically reducing environment around the cluster thereby allowing further accelerated reduction of silver ions at the interface between peptide and metal. In addition, the peptides adhere to the silver nuclei leading to lower surface energy of the crystal lattice, for example lowered surface energy of the [111] face enables accelerated growth at the re-entrant edges. The large size and shape distribution of the crystals observed could be in part due to the formation of twinned crystals, i.e., the large nuclei and crystals may develop multiple twins (FIG. 6). In the past, twining has been used to explain the shape and size distribution of flat gold particles 6. Clearly, the selected peptides contain amino acid moieties that provide both recognition and reduction, since pure amino acids and other peptides do not exhibit silver precipitation (Supplemental Table 1). Amino acid residues such as arginine, cysteine, lysine and methionine are known to interact with silver ions 19. In comparing the three peptides, AG5 peptide due to its basic charge may not bind as strongly as AG3 and AG4 to the metal clusters, but it does contain amino acid moieties that could otherwise assist in the reduction of silver ions. On going protein modeling studies will provide a clearer understanding of the role of these different silver-binding peptides with respect to surface interactions.

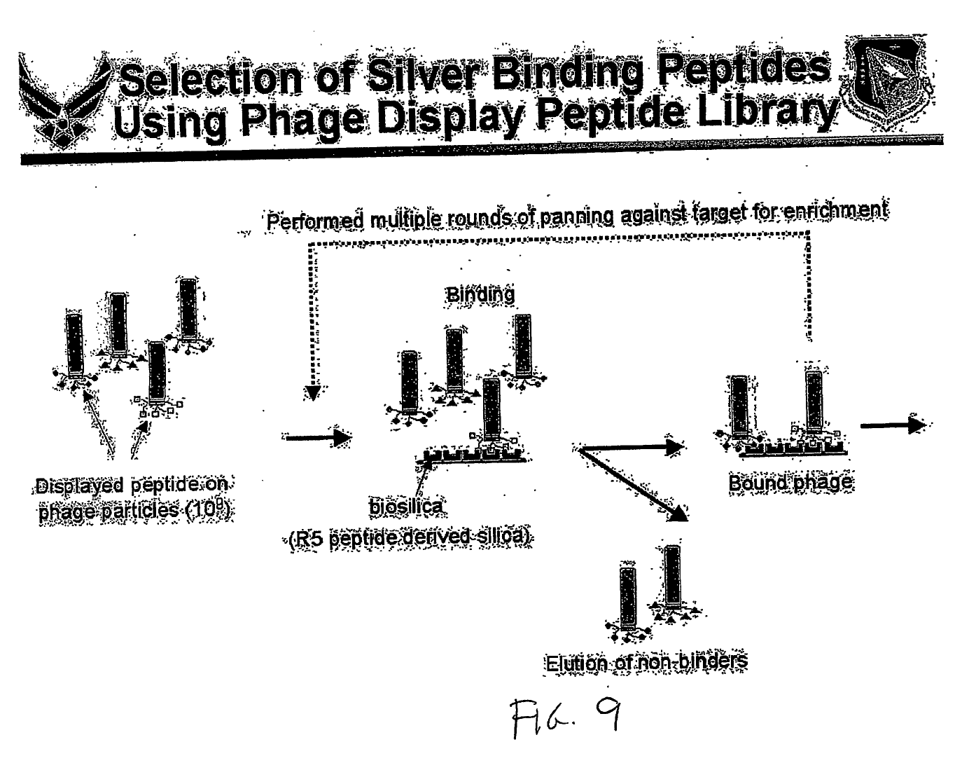

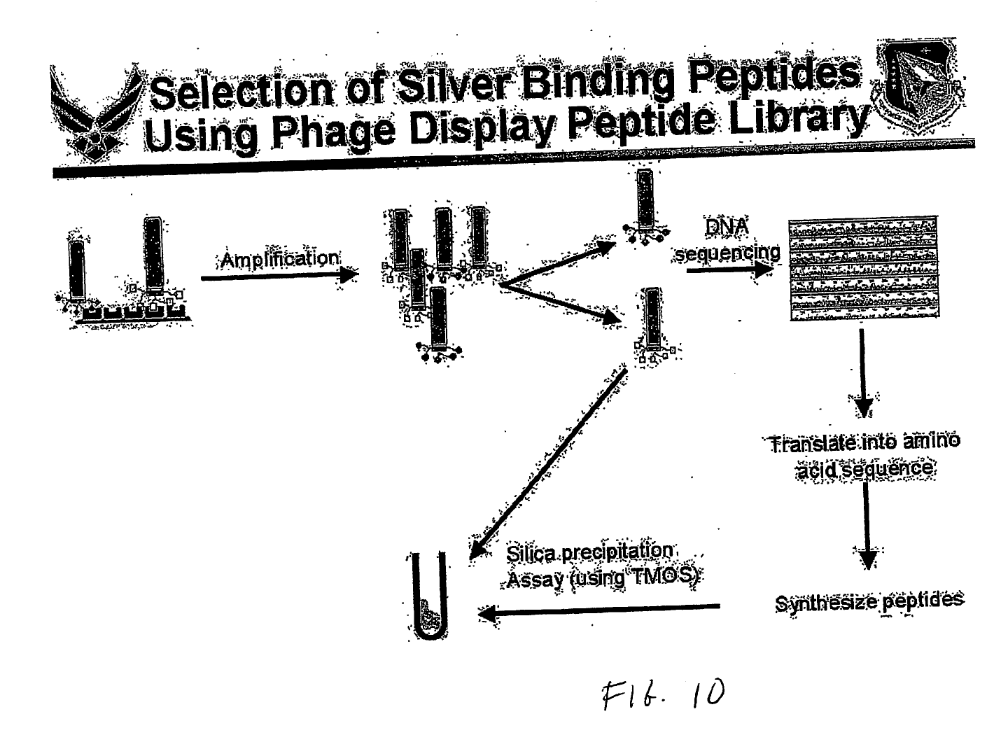

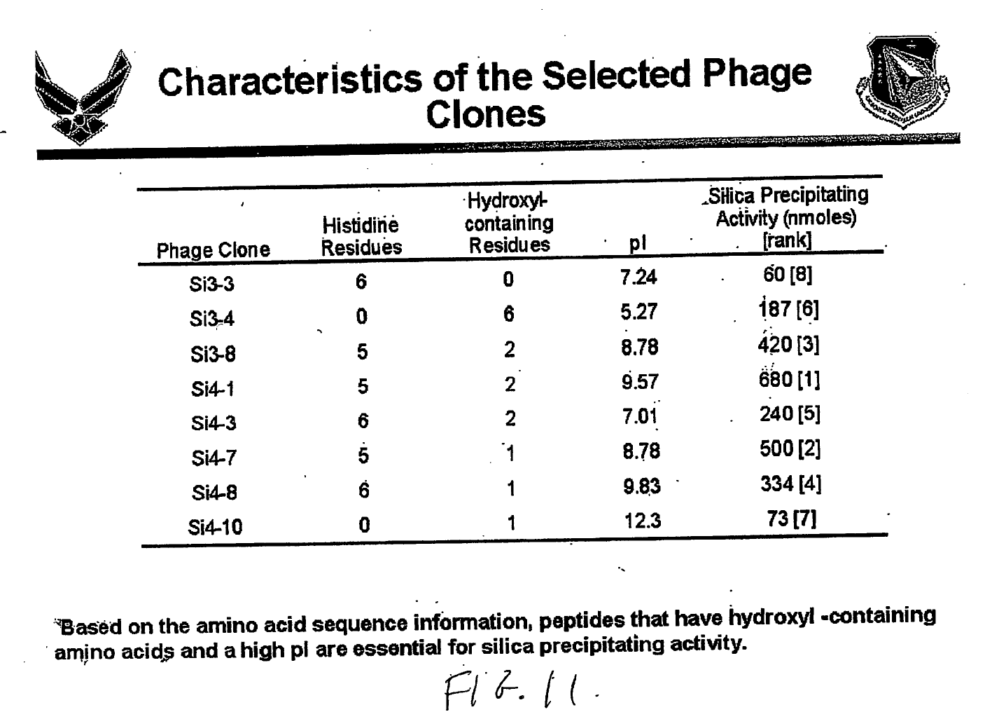

Peptides that serve as templates for inorganic deposition, offer a way for spatially controlling the deposition of inorganic material into an ordered array 10, 13. Using the micromolding in capillaries (MIMIC) technique to spatially control the deposition AG4 peptide on a glass substrate, we were able to create an array of silver crystals (FIG. 8. In MIMIC, an elastomeric mold is placed on the surface of a substrate, and the pattern in the elastomer is used to define a network of microfluidic channels between the stamp and substrate 20,21. After incubation of the AG4 patterned substrate with aqueous silver nitrate, large aggregates of silver particles were deposited in regions that contained the AG4 peptide (FIG. 8B). The silver particles were only deposited in regions containing the AG4 peptide and not in the surrounding areas or between the microchannels. The silver crystals autofluoresce when illuminated with a mercury lamp due to the light scattering property of the silver nanoparticles on the glass surface (FIG. 8C).

In summary, we have demonstrated the biosynthesis of silver nanoparticles using peptides selected by their ability to bind to the surface of silver particles. By the very nature of peptide selection against metal particles, a “memory effect” has been imparted to the selected peptides. As nuclei or metal clusters form in solution, a variety of phases are expected, and we speculate that the selected peptides interact with these clusters to accelerate growth of a particular phase or phases 22. Clearly, the use of biomolecules in accordance with the invention may be useful in methods of precipitation and developing inorganic material structures on a nanometric level, and may be particularly useful in the bottom-up fabrication of nanoscale devices.

TABLE 1
Amino acid sequences and properties of the
silver-selected peptides..

Isoelectric ^{a}
pH(pl)

| | | |
|---|---|---|
| Ag3 | A Y S S G A P P M P P F | 5.57 |
| Ag4 | N P S S L F R Y L P S D | 6.09 |
| Ag5 | S L A T Q P P R T P P V | 9.47 |
| | ● ● ● ★ ● | |

^{a} Isoelectric pl calculated using pl/Mass program at Amino acids with functional side groups are shaded, conserved amino acids in all three sequences (star) or in two of the three sequences (circle)

The following references referred to in the above example are incorporated by reference as if set forth in their entirety herein:
1. Lowenstam, H. A. Minerals formed by organisms. Science 211, 1126-1130 (1981).
2. Mann, S. Biomineralization: Principles and concepts in bioinorganic materials chemistry. (Oxford University Press, Oxford, 2001).
3. Cha, J. N. et al. Silicatein filaments and subunits from a marine sponge direct the polymerization of silica and silicones in vitro. Proc. Natl. Acad. Sci. USA 96, 361-365 (1999).
4. Klaus, T., Joerger, R., Olsson, E. & Granqvist, C. G. Silver-based crystalline nanoparticles, microbially fabricated. Proc. Natl. Acad. Sci. U.S.A. 96, 13611-13614 (1999).
5. Dameron, C. T., et al. Biosynthesis of cadmium sulphide quantum semiconductor crystallites. Nature 338, 596-597 (1989).
6. Brown, S., Sarikaya, M. & Johnson, E. A genetic analysis of crystal growth. J. Mol. Biol. 299, 725-735 (2000).
7. Cha, J. N., Stucky, G. D., Morse, D. E. & Deming, T. J. Biomimetic synthesis of ordered silica structures mediated by block copolypeptides. Nature 403, 289-292 (2000).
8. Naik, R. R., Brott, L. L., Clarson, S. J. & Stone, M. O. Silica-precipitating peptides isolated from a combinatorial phage display library. J. Nanosci. Nanotech 2, 95-100 (2002).
9. Douglas, T. et al. Protein engineering of a viral cage for constrained nanometrials synthesis. Adv. Mater. 14, 415-418 (2002).
10. Lee, S.-W., Mao, C., Flynn, C. E. & Belcher, A. M. Ordering of quantum dots using genetically engineered viruses. Science 296, 892-895 (2002).
11. Kroger, N., Deutzmann, R. & Sumper, M. Polycationic peptides from diatom biosilica that direct silica nanosphere formation. Science 286, 1129-1132 (1999).
12. Aizenberg J., Lambert, G., Addadi, L. & Weiner, S. Stabilization of amorphous calcium carbonate by specialized macromolecules in biological and synthetic precipitates. Adv. Mater. 8, 222-225 (1996).
13. Brott, L. L. et al., Ultrafast holographic patterning of biocatalytically-formed silica. Nature 413, 291-293 (2001).
14. Brown, S. Metal-recognition by repeating polypeptides. Nature Biotechnol. 15, 269-272 (1997).
15. Gaskin, D. J. H., Starck, K. & Vulfson, E. N. Identification of inorganic crystal-specific sequences using phage display combinatorial library of short peptides: A feasibility study. Biotech. Letts. 22, 1211-1216 (2000).
16. Whaley, S. R., English, D. S., Hu, E. L., Barbara, P. F. & Belcher, A. M. Selection of peptides with semiconductor binding specificity for directed nanocrystal assembly. Nature 405, 665-668 (2000).
17. Schatz, G. C. & Van Duyne, R. P. Handbook of vibrational spectroscopy. (eds. Chalmers, J. M. & Griffiths, P. R.) (Wiley, New York, 2002).
18. Aizenberg J., Lambert, G., Weiner, S. & Addadi, L. Factors involved in the formation of amorphous and crystalline calcium carbonate: a study of an ascidian skeleton. J. Am. Chem. Soc. 124, 32-39 (2001).
19. Gruen, L. C. Interaction of amino acids with silver ions. Biochim. Biophys. Acta 386, 270-274 (1975).
20. Kim, E., Xia, Y. & Whitesides, G. M. Polymer microstructures formed by moulding in capillaries. Nature 376, 581-584 (1995).
21. Delamarche, E., Bernard, A., Schmid, H., Michel, B. & Biebuyck, H. Patterned delivery of immunoglobulins to surfaces using microfluidic networks. Science 276, 779-781 (1997).
22. Weissbuch, I., Addadi, L., Lahav, M. & Leiserowitz, L. Molecular recognition at crystal interfaces. Science 253, 637-645 (1991).

### Example 3

### Preparation of Cobalt Oxide Binding Peptides in Accordance with the Invention

Isolation of Cobalt Oxide Binding Peptides. In accordance with the invention, a 12 amino acid phage peptide display library (PhD-12, New England Biolabs, Inc., Beverly, Mass.) was utilized in the isolation and identification of cobalt oxide binding peptides. The target binding, elution and amplification was carried out according to manufacturers instructions as recited in the above examples. In this case, the library was incubated with washed particles of cobalt oxide to pan for phages producing peptides which bound to cobalt oxide. Phage were eluted from the particles as set forth above, and subjected to 34 additional rounds of panning with cobalt oxide. After the final panning procedure, E. coli ER2537 host-cells were infected with the eluted phage and plated on Luria Broth (LB) plates to enable the isolation of nucleic acid (DNA) from the resulting phage producing cobalt oxide binding peptides. The sequences were determined using an automated sequencer.

From sequencing of the selected phage, the following peptides were identified as peptides which could bind cobalt oxide and thus be useful in accordance with the invention:

Cobalt Oxide Binding Peptides

| | | |
|---|---|---|
| c6-7 | --HPPTDWMVPSPP-- 12 | (SEQ ID NO: 13) |
| c6-9 | -TWQPFG-MRPSDP-- 12 | (SEQ ID NO: 14) |
| C2 | ---HSVRWLLPGAHP- 12 | (SEQ ID NO: 15) |
| c5-3 | -KLHSSPHTLP-VQ-- 12 | (SEQ ID NO: 16) |
| c5-6 | ---TNLDPSYPLH-HL 12 | (SEQ ID NO: 17) |
| c5-7 | --LPLLGDSIPHS-H- 12 | (SEQ ID NO: 18) |
| c5-8 | ---SPL-QVLPYQGYV 12 | (SEQ ID NO: 19) |
| c9 | ---TPNSDALLTPAL- 12 | (SEQ ID NO: 20) |
| c5-2 | --WTPGSTGLFHPN-- 12 | (SEQ ID NO: 21) |
| c10 | ---QHITQSIWPGVR- 12 | (SEQ ID NO: 22) |
| c6-8 | ---QNFLQVIRNAPR- 12 | (SEQ ID NO: 23) |
| c5 | ---ESPIALAGLSDK- 12 | (SEQ ID NO: 24) |
| c5-4 | --PHILLTQMTSSG-- 12 | (SEQ ID NO: 25) |
| c6-4 | ----QLSKLISVSGSA 12 | (SEQ ID NO: 26) |
| c5-10 | ---TPLP-MIPAKTSF 12 | (SEQ ID NO: 27) |
| c3 | HETNPPATIMPH---- 12 | (SEQ ID NO: 28) |
| c6-3 | ---TGDVSNNPNVTL- 12 | (SEQ ID NO: 29) |
| c6-2 | --HAMTPQVHPNYA-- 12 | (SEQ ID NO: 30) |
| c6-6 | -YGNQTPYWYPHR--- 12 | (SEQ ID NO: 31) |
| c7 | ---TARTNEYPTGTS- 12 | (SEQ ID NO: 32) |
| c8 | ---RPAIVTQPWTIE- 12 | (SEQ ID NO: 33) |
| c5-1 | ---SLTQRVRPWAFY- 12 | (SEQ ID NO: 34) |
| c4 | --WASAAWLVHSTI-- 12 | (SEQ ID NO: 35) |
| c6-5 | -VLVAEQRVIMDQ--- 12 | (SEQ ID NO: 36) |
| Co-1 | SVSVGMKPSP-RP 12 | (SEQ ID NO: 37) |
| Co-12 | GTST-FNSVPVRD 12 | (SEQ ID NO: 38) |
| Co-13 | SAPN-LNALSAAS 12 | (SEQ ID NO: 39) |

### Example 4

### Preparation of Iron Oxide Binding Peptides in Accordance with the Invention

Isolation of Iron Oxide Binding Peptides. In accordance with the invention, a 12 amino acid phage peptide display library (PhD-12, New England Biolabs, Inc., Beverly, Mass.) was utilized in the isolation and identification of iron oxide binding peptides. The target binding, elution and amplification was carried out according to manufacturer's instructions as recited in the above examples. In this case, the library was incubated with washed particles of iron oxide to pan for phages producing peptides which bound to iron oxide. Phage were eluted from the particles as set forth above, and subjected to 3-4 additional rounds of panning with iron oxide. After the final panning procedure, E. coli ER2537 host cells were infected with the eluted phage and plated on Luria Broth (LB) plates to enable the isolation of nucleic acid (DNA) from the resulting phage producing iron oxide binding peptides. The sequences were determined using an automated sequencer.

From sequencing of the selected phage, the following peptides were identified as peptides which could bind iron oxide and thus be useful in accordance with the invention:

Iron Oxide Binding Peptides

| | | |
|---|---|---|
| RN-22 | TGIPKSLTVTFP | (SEQ ID NO: 40) |
| RN-23 | NLSTYLKTAVPP | (SEQ ID NO: 41) |
| RN-24 | SHNLEKSTARYP | (SEQ ID NO: 42) |
| RN-25 | SPGKTPGWVSSD | (SEQ ID NO: 43) |
| RN-27 | MNVTLSSSLDGP | (SEQ ID NO: 44) |
| RN-28 | QSFASLTNPRVL | (SEQ ID NO: 45) |
| RN-29 | VYIPKTPHAAPP | (SEQ ID NO: 46) |
| RN-30 | MNSIKPKPHHKN | (SEQ ID NO: 47) |
| RN-31 | GVLNAAQTWALS | (SEQ ID NO: 48) |
| RN-33 | TSSTKITWISTPS | (SEQ ID NO: 49) |
| RN-34 | VSFKPMALDFKF | (SEQ ID NO: 50) |
| RN-35 | LTQPTSKSPTMI | (SEQ ID NO: 51) |
| RN-36 | AMIPIAHHSANL | (SEQ ID NO: 52) |
| RN-37 | QHANHQAWNNLR | (SEQ ID NO: 53) |
| RN-38 | IHSVHFRSPPHP | (SEQ ID NO: 54) |
| RN-40 | MNMNQYTILSRT | (SEQ ID NO: 55) |

What is claimed is:

1. A method for identifying peptides which can bind to an inorganic material using a combinatorial phage display library comprising:
a. incubating a combinatorial phage peptide display library with a target inorganic material which will bind to peptides expressed by the phage of the library;
b. eluting the library so as to collect the phage bound to the target inorganic material;
c. isolating the nucleic acid of the phage bound to the target inorganic material; and
d. sequencing said nucleic acid so as to determine the sequence of the peptides coded by the nucleic acid of the phage which can bind to the target inorganic material.

2. The method of claim 1 further comprising a step of expressing the peptide identified by steps a-d.

3. The method of claim 1 wherein steps a-b are repeated so as to increase the purification of the phage bound to the inorganic material.

4. The method of claim 1 wherein the peptide expressed by the phage is capable of catalyzing the deposition or precipitation, or controlling or directing the growth of the target inorganic material.

5. The method of claim 1 wherein the inorganic material is selected from the group consisting of silica, silver, germanium, cobalt, iron, and oxides thereof.

6. The method of claim 1 wherein the inorganic material is selected from the group consisting of aluminum, antimony, beryllium, cadmium, copper, gold, iron, lead, selenium, palladium, platinum, and zinc, and oxides thereof.

7. The method of claim 1 wherein the inorganic material is a radioactive material.

8. The method of claim 7 wherein the radioactive material is selected from the group consisting of radioactive cobalt and uranium.

9. A peptide identified by the method of claim 1.

10. A peptide according to claim 9 wherein said peptide binds to a material selected from the group consisting of silica, silver, germanium, cobalt, iron, and oxides thereof.

11. A peptide according to claim 9 wherein the inorganic material bound by the peptide is selected from the group consisting of aluminum, antimony, beryllium, cadmium, copper, gold, iron, lead, nickel, selenium, palladium, platinum, and zinc, and oxides thereof.

12. A peptide according to claim 9 wherein the inorganic material bound by the peptide is a radioactive material.

13. The method of claim 12 wherein the radioactive material is selected from the group consisting of radioactive cobalt and uranium.

14. A peptide according to claim 9 wherein said peptide binds to silica, and wherein the sequence of said peptide is selected from the group consisting of SEQ ID NOS: 1-8.

15. A peptide according to claim 9 wherein said peptide binds to silver, and wherein the sequence of said peptide is selected from the group consisting of SEQ ID NOS: 10-12.

16. A peptide according to claim 9 wherein said peptide binds to germanium, and wherein the sequence of said peptide is SEQ ID NO: 9.

17. A peptide according to claim 9 wherein said peptide binds to cobalt oxide, and wherein the sequence of said peptide is selected from the group consisting of SEQ ID NOS 13-39.

18. A peptide according to claim 9 wherein said peptide binds to iron oxide, and wherein the sequence of said peptide is selected from the group consisting of SEQ ID NOS 40-55.

19. A method for obtaining phage which can express a peptide which can bind to an inorganic material using a combinatorial phage display library comprising:
a. incubating a combinatorial phage display peptide library with a target inorganic material which will bind to peptides expressed by the phage of the library; and
b. eluting the library so as to collect the phage bound to the target inorganic material.

20. A method of initiating the deposition or precipitation of an inorganic material on a nanometric scale comprising expressing a peptide obtained by the method of claim 1, and using said peptide as a template to initiate the deposition or precipitation of said inorganic material.

21. The method according to claim 20 wherein said inorganic material is selected from the group consisting of silica, silver, germanium, cobalt, iron, and oxides thereof.

22. A nucleic acid encoding a peptide according to claim 9.

23. A nucleic acid according to claim 16 wherein the nucleic acid encodes a peptide having a sequence selected from the group consisting of SEQ ID NOS: 1-55.

24. A method for recovering an inorganic material using a peptide according to claim 9 comprising:
a. providing the peptide of claim 1 in an amount effective to reduce or eliminate the inorganic ingredient to which said peptide will bind;
b. introducing said peptide into a solution containing the inorganic material to be removed and maintaining the peptide in said solution for a time sufficient for the peptide to bind with said inorganic material; and
c. removing said peptide after it has become bound to said inorganic material so as to recover the inorganic material.

25. A method according to claim 24 wherein said inorganic material is a radioactive material.

26. A method for delivering an inorganic material using a peptide according to claim 9 comprising:
a. providing the peptide of claim 1 in an amount effective to bind to the inorganic ingredient to which said peptide will bind;
b. linking said bound peptide with a molecule that can target a site to where said inorganic material is to be delivered; and
c. introducing said peptide so that it will reach the site to where it is directed.

27. A method according to claim 26 wherein said inorganic material is a radioactive material.

28. A method according to claim 26 wherein said delivery of said inorganic material is to a human or animal patient.

29. A method according to claim 26 wherein said peptide is linked to an antibody capable of targeting a particular tumor cell so as to direct the inorganic material bound to said peptide to a tumor site.

30. A cartridge for filtering or recovering an inorganic material comprising the peptide according to claim 9 and a suitable support.

31. The cartridge according to claim 30 wherein said solid support is a resin or a polysaccharide.

32. A method for identifying peptides which can bind to a stable inorganic element or a stable inorganic complex of said element using a combinatorial phage display library comprising:
a. incubating a combinatorial phage display peptide library with a target inorganic element or complex which will bind to peptides expressed by the phage of the library;
b. eluting the library so as to collect the phage bound to the target inorganic element or complex;
c. isolating the nucleic acid of the phage bound to the target inorganic element or complex; and
d. sequencing said nucleic acid so as to determine the sequence of the peptides coded by the nucleic acid of the phage which can bind to the target inorganic element or complex.


SEQUENCE LISTING (57 sequences)

SEQ ID NO: 1 - protein, 12 aa, Bacteriophage PhD-12
APPGHHHWHIHH

SEQ ID NO: 2 - protein, 12 aa, Bacteriophage PhD-12
MSASSYASFSWS

SEQ ID NO: 3 - protein, 12 aa, Bacteriophage PhD-12
KPSHHHHHTGAN

SEQ ID NO: 4 - protein, 12 aa, Bacteriophage PhD-12
MSPHPHPRHHHT

SEQ ID NO: 5 - protein, 12 aa, Bacteriophage PhD-12
MSPHHMHHSHGH

SEQ ID NO: 6 - protein, 12 aa, Bacteriophage PhD-12
LPHHHHLHTKLP

SEQ ID NO: 7 - protein, 12 aa, Bacteriophage PhD-12
APHHHHPHHLSR

SEQ ID NO: 8 - protein, 12 aa, Bacteriophage PhD-12
RGRRRRLSCRLL

SEQ ID NO: 9 - protein, 12 aa, Bacteriophage PhD-12
TVASNSGLRPAS

SEQ ID NO: 10 - protein, 12 aa, Bacteriophage PhD-12
AYSSGAPPMPPF

SEQ ID NO: 11 - protein, 12 aa, Bacteriophage PhD-12
NPSSLFRYLPSD

SEQ ID NO: 12 - protein, 12 aa, Bacteriophage PhD-12
SLATQPPRTPPV

SEQ ID NO: 13 - protein, 12 aa, Bacteriophage PhD-12
HPPTDWMVPSPP

SEQ ID NO: 14 - protein, 12 aa, Bacteriophage PhD-12
TWQPFGMRPSDP

SEQ ID NO: 15 - protein, 12 aa, Bacteriophage PhD-12
HSVRWLLPGAHP

SEQ ID NO: 16 - protein, 12 aa, Bacteriophage PhD-12
KLHSSPHTLPVQ

SEQ ID NO: 17 - protein, 12 aa, Bacteriophage PhD-12
TNLDPSYPLHHL

SEQ ID NO: 18 - protein, 12 aa, Bacteriophage PhD-12
LPLLGDSIPHSH

SEQ ID NO: 19 - protein, 12 aa, Bacteriophage PhD-12
SPLQVLPYQGYV

SEQ ID NO: 20 - protein, 12 aa, Bacteriophage PhD-12
TPNSDALLTPAL

SEQ ID NO: 21 - protein, 12 aa, Bacteriophage PhD-12
WTPGSTGLFHPN

SEQ ID NO: 22 - protein, 12 aa, Bacteriophage PhD-12
QHITQSIWPGVR

SEQ ID NO: 23 - protein, 12 aa, Bacteriophage PhD-12
QNFLQVIRNAPR

SEQ ID NO: 24 - protein, 12 aa, Bacteriophage PhD-12
ESIPALAGLSDK

SEQ ID NO: 25 - protein, 12 aa, Bacteriophage PhD-12
PHILLTQMTSSG

SEQ ID NO: 26 - protein, 12 aa, Bacteriophage PhD-12
QLSKLISVSGSA

SEQ ID NO: 27 - protein, 12 aa, Bacteriophage PhD-12
TPLPMIPAKRSF

SEQ ID NO: 28 - protein, 12 aa, Bacteriophage PhD-12
HETNPPATIMPH

SEQ ID NO: 29 - protein, 12 aa, Bacteriophage PhD-12
TGDVSNNPNVTL

SEQ ID NO: 30 - protein, 12 aa, Bacteriophage PhD-12
HAMRPQVHPNYA

SEQ ID NO: 31 - protein, 12 aa, Bacteriophage PhD-12
YGNQTPYWYPHR

SEQ ID NO: 32 - protein, 12 aa, Bacteriophage PhD-12
TARTNEYPTGTS

SEQ ID NO: 33 - protein, 12 aa, Bacteriophage PhD-12
RPAIVTQPWTIE

SEQ ID NO: 34 - protein, 12 aa, Bacteriophage PhD-12
SLTQTVTPWAFY

SEQ ID NO: 35 - protein, 12 aa, Bacteriophage PhD-12
WASAAWLVHSTI

SEQ ID NO: 36 - protein, 12 aa, Bacteriophage PhD-12
VLVAEQRVIMDQ

SEQ ID NO: 37 - protein, 12 aa, Bacteriophage PhD-12
SVSVGMKPSPRP

SEQ ID NO: 38 - protein, 12 aa, Bacteriophage PhD-12
GTSTFNSVPVRD

SEQ ID NO: 39 - protein, 12 aa, Bacteriophage PhD-12
SAPNLNALSAAS

SEQ ID NO: 40 - protein, 12 aa, Bacteriophage PhD-12
TGIPKSLTVTFP

SEQ ID NO: 41 - protein, 12 aa, Bacteriophage PhD-12
NLSTYLKTAVPP

SEQ ID NO: 42 - protein, 12 aa, Bacteriophage PhD-12
SHNLEKSTARYP

SEQ ID NO: 43 - protein, 12 aa, Bacteriophage PhD-12
SPGKTPGWVSSD

SEQ ID NO: 44 - protein, 12 aa, Bacteriophage PhD-12
MNVTLSSSLDGP

SEQ ID NO: 45 - protein, 12 aa, Bacteriophage PhD-12
QSFASLTNPRVL

SEQ ID NO: 46 - protein, 12 aa, Bacteriophage PhD-12
VYIPKTPHAAPP

SEQ ID NO: 47 - protein, 12 aa, Bacteriophage PhD-12
MNSIKPKPHHKN

SEQ ID NO: 48 - protein, 12 aa, Bacteriophage PhD-12
GVLNAAQTWALS

SEQ ID NO: 49 - protein, 12 aa, Bacteriophage PhD-12
TSSTKITWSTPS

SEQ ID NO: 50 - protein, 12 aa, Bacteriophage PhD-12
VSFKPMALDFKF

SEQ ID NO: 51 - protein, 12 aa, Bacteriophage PhD-12
LTQPTSKSPTMI

SEQ ID NO: 52 - protein, 12 aa, Bacteriophage PhD-12
AMIPIAHHSANL

SEQ ID NO: 53 - protein, 12 aa, Bacteriophage PhD-12
QHANHQAWNNLR

SEQ ID NO: 54 - protein, 12 aa, Bacteriophage PhD-12
IHSVHFRSPPHP

SEQ ID NO: 55 - protein, 12 aa, Bacteriophage PhD-12
MNMNQYTILSRT

SEQ ID NO: 56 - protein, 12 aa, Bacteriophage GE 10
SFLYSYTGPRPL

SEQ ID NO: 57 - protein, 12 aa, Bacteriophage MT 1
GTGEGCKTGCKC